(19) United States
(12) Patent Application Publication
(10) Pub. No.: US 2018/0032344 A1
(43) Pub. Date: Feb. 1, 2018

(54) OUT-OF-ORDER BLOCK-BASED PROCESSOR

(71) Applicant: Microsoft Technology Licensing, LLC, Redmond, WA (US)

(72) Inventors: Aaron L. Smith, Seattle, WA (US); Jan S. Gray, Bellevue, WA (US)

(73) Assignee: Microsoft Technology Licensing, LLC, Redmond, WA (US)

(21) Appl. No.: 15/224,592

(22) Filed: Jul. 31, 2016

(51) Int. Cl. G06F 9/38; G06F 9/30

(52) U.S. Cl. CPC G06F 9/3855; G06F 9/30043; G06F 9/3016; G06F 9/3802

(57) ABSTRACT

Technology related to out-of-order processor architectures is disclosed. In one example of the disclosed technology, a processor includes decode logic and issue logic. The decode logic is configured to decode a store mask of an instruction block. The instruction block can include load and store instructions. Each load and store instruction includes an identifier specifying a relative program order of the load or store instruction within the instruction block. The store mask identifies positions of the store instructions within the program order of the instruction block. The issue logic is configured to issue at least one of the instructions of the instruction block out of program order. The issue logic can be configured to use the decoded store mask to only issue load instructions after all store instructions preceding the load instructions have issued.

### BACKGROUND

Microprocessors have benefitted from continuing gains in transistor count, integrated circuit cost, manufacturing capital, clock frequency, and energy efficiency due to continued transistor scaling predicted by Moore's law, with little change in associated processor Instruction Set Architectures (ISAs). However, the benefits realized from photolithographic scaling, which drove the semiconductor industry over the last 40 years, are slowing or even reversing. Reduced Instruction Set Computing (RISC) architectures have been the dominant paradigm in processor design for many years. Out-of-order superscalar implementations have not exhibited sustained improvement in area or performance. Accordingly, there is ample opportunity for improvements in processor ISAs to extend performance improvements.

### SUMMARY

Methods, systems, apparatus, and computer-readable storage devices are disclosed for a block-based processor instruction set architecture (BB-ISA). The described techniques and tools can potentially improve processor performance and can be implemented separately, or in various combinations with each other. As will be described more fully below, the described techniques and tools can be implemented in a digital signal processor, microprocessor, application-specific integrated circuit (ASIC), a soft processor (e.g., a microprocessor core implemented in a field programmable gate array (FPGA) using reconfigurable logic), programmable logic, or other suitable logic circuitry. As will be readily apparent to one of ordinary skill in the art, the disclosed technology can be implemented in various computing platforms, including, but not limited to, servers, mainframes, cellphones, smartphones, PDAs, handheld devices, handheld computers, touch screen tablet devices, tablet computers, wearable computers, and laptop computers.

In some examples of the disclosed technology, a processor includes decode logic and issue logic. The decode logic is configured to decode a store mask of an instruction block. The instruction block can include load and store instructions, where each load and store instruction includes an identifier specifying a relative program order of the load or store instruction within the instruction block. The store mask identifies positions of the store instructions within the program order of the instruction block. The issue logic is configured to issue at least one of the instructions of the instruction block out of program order. The issue logic can be configured to use the decoded store mask to only issue load instructions after all store instructions preceding the load instructions have issued.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The foregoing and other objects, features, and advantages of the disclosed subject matter will become more apparent from the following detailed description, which proceeds with reference to the accompanying figures.

### BRIEF DESCRIPTION OF THE DRAWINGS

FIG. 1 illustrates a block-based processor including multiple processor cores, as can be used in some examples of the disclosed technology.

FIG. 2 illustrates a block-based processor core, as can be used in some examples of the disclosed technology.

FIG. 3 illustrates a number of instruction blocks, according to certain examples of disclosed technology.

FIG. 4 illustrates portions of source code and respective instruction blocks.

FIG. 5 illustrates block-based processor headers and instructions, as can be used in some examples of the disclosed technology.

FIG. 6 is a flowchart illustrating an example of a progression of states of a processor core of a block-based processor.

FIG. 7 illustrates an example snippet of instructions of a program for a block-based processor.

FIG. 8 illustrates an example system including an out-of-order processor for executing an instruction block on a block-based processor core, as can be used in some examples of the disclosed technology.

FIG. 9 illustrates an example of load-store issue logic, as can be used in some examples of the disclosed technology.

FIG. 10 is a flowchart illustrating an example method of maintaining a load-store data structure of the load-store issue logic, as can be performed in some examples of the disclosed technology.

FIG. 11 is a flowchart illustrating an example method of issuing load and store instructions, as can be performed in some examples of the disclosed technology.

FIGS. 12-13 are flowcharts illustrating example methods of executing an instruction block on a block-based processor core, as can be performed in some examples of the disclosed technology.

FIG. 14 is a block diagram illustrating a suitable computing environment for implementing some embodiments of the disclosed technology.

### DETAILED DESCRIPTION

### I. General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “emit,” “verify,” “execute,” and “initiate” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., computer-readable storage media). The computer-executable instructions can be part of, for example, a dedicated software application or a software application that is accessed or downloaded via a web browser or other software application (such as a remote computing application). Such software can be executed, for example, on a single local computer (e.g., with general-purpose and/or block-based processors executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### II. Introduction to the Disclosed Technologies

Superscalar out-of-order microarchitectures employ substantial circuit resources to rename registers, schedule instructions in dataflow order, clean up after miss-speculation, and retire results in-order for precise exceptions. This includes expensive energy-consuming circuits, such as deep, many-ported register files, many-ported content-accessible memories (CAMs) for dataflow instruction scheduling wakeup, and many-wide bus multiplexers and bypass networks, all of which are resource intensive. For example, FPGA-based implementations of multi-read, multi-write-port random-access memories (RAMs) typically require a mix of replication, multi-cycle operation, clock doubling, bank interleaving, live-value tables, and other expensive techniques.

The disclosed technologies can realize energy efficiency and/or performance enhancement through application of techniques including high instruction-level parallelism (ILP), out-of-order, superscalar execution, while avoiding substantial complexity and overhead in both processor hardware and associated software. In some examples of the disclosed technology, a block-based processor comprising multiple processor cores uses an Explicit Data Graph Execution (EDGE) ISA designed for area- and energy-efficient, high-ILP execution. In some examples, use of EDGE architectures and associated compilers finesses away much of the register renaming, CAMs, and complexity. In some examples, the respective cores of the block-based processor can store or cache fetched and decoded instructions that may be repeatedly executed, and the fetched and decoded instructions can be reused to potentially achieve reduced power and/or increased performance.

In certain examples of the disclosed technology, an EDGE ISA can eliminate the need for one or more complex architectural features, including register renaming, dataflow analysis, misspeculation recovery, and in-order retirement while supporting mainstream programming languages such as C and C++. In certain examples of the disclosed technology, a block-based processor executes a plurality of two or more instructions as an atomic block. Block-based instructions can be used to express semantics of program data flow and/or instruction flow in a more explicit fashion, allowing for improved compiler and processor performance. In certain examples of the disclosed technology, an explicit data graph execution instruction set architecture (EDGE ISA) includes information about program control flow that can be used to improve detection of improper control flow instructions, thereby increasing performance, saving memory resources, and/or and saving energy.

In some examples of the disclosed technology, instructions organized within instruction blocks are fetched, executed, and committed atomically. Intermediate results produced by the instructions within an atomic instruction block can be buffered locally until the instruction block is committed. When the instruction block is committed, updates to the visible architectural state resulting from executing the instructions of the instruction block are made visible to other instruction blocks. Instructions inside blocks execute in dataflow order, which reduces or eliminates using register renaming and provides power-efficient out-of-order execution. A compiler can be used to explicitly encode data dependencies through the ISA, reducing or eliminating burdening processor core control logic from rediscovering dependencies at runtime. Using predicated execution, intra-block branches can be converted to dataflow instructions, and dependencies, other than memory dependencies, can be limited to direct data dependencies. Disclosed target form encoding techniques allow instructions within a block to communicate their operands directly via operand buffers, reducing accesses to a power-hungry, multi-ported physical register files.

Between instruction blocks, instructions can communicate using visible architectural state such as memory and registers. Thus, by utilizing a hybrid dataflow execution model, EDGE architectures can still support imperative programming languages and sequential memory semantics, but desirably also enjoy the benefits of out-of-order execution with near in-order power efficiency and complexity.

Out-of-order processors can include hardware to track in-flight load and store instructions for accessing memory. In-flight instructions can include loads that have issued but have not responded with load data and stores that have issued but have not been written back to the memory. When typical out-of-order processors execute load and store instructions out-of-order, the processors use a load-store queue to enforce sequential memory semantics. The load-store queue can buffer the data of load and store instructions before the data is written to memory. A typical load-store queue uses a content addressable memory (CAM) to track the in-flight load and store instructions and to identify potential data dependencies. While CAMs can achieve high performance, they can be expensive in terms of chip area and energy usage. For example, a CAM can have a different comparator for each entry in the CAM so that all entries in the CAM can be tested in a single cycle. Each of the different comparators consumes chip area and energy.

As disclosed herein, a processor can execute instructions out of program order without using a load-store queue. In particular, the processor can include an instruction scheduler that enforces sequential memory semantics while enabling some instructions to execute out of program order. By using the scheduler to enforce sequential memory semantics, the energy and circuitry area for the load-store queue can be reduced or eliminated. In other words, the processor can be made smaller and more energy efficient by omitting a load-store queue. The scheduler can potentially be made more efficient when the scheduler uses information generated by a compiler about a structure of a program and sequence information about the load and store instructions. For example, the program can be divided into predefined instruction blocks with a maximum number of load and store instructions. The sequential order of the load and store instructions relative to each other can be encoded within the instructions themselves. The position of the store instructions within the sequential order can be identified and encoded in an instruction header of the instruction block. The scheduler can use one or more of the encoded ordering information of each instruction and the position of the store instructions to schedule the instructions to be executed out of program order while respecting the order of memory operations.

As will be readily understood to one of ordinary skill in the relevant art, a spectrum of implementations of the disclosed technology are possible with various area, performance, and power tradeoffs.

### III. Example Block-Based Processor

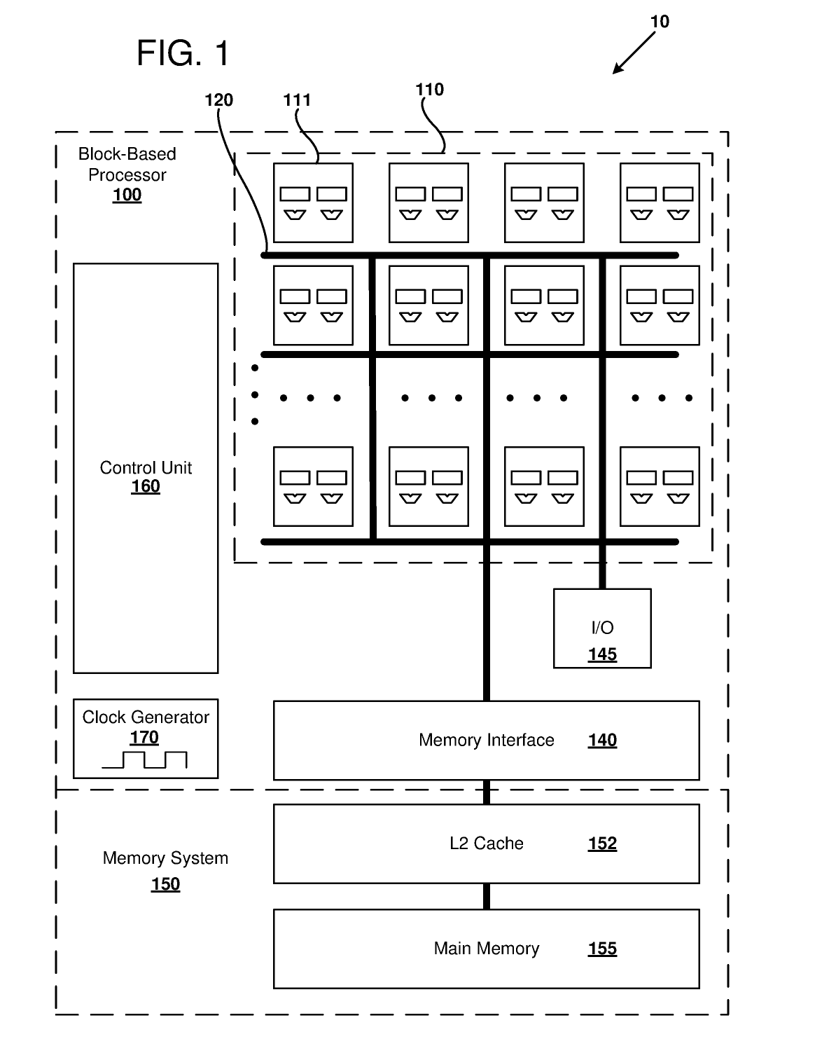

FIG. 1 is a block diagram 10 of a block-based processor 100 as can be implemented in some examples of the disclosed technology. The processor 100 is configured to execute atomic blocks of instructions according to an instruction set architecture (ISA), which describes a number of aspects of processor operation, including a register model, a number of defined operations performed by block-based instructions, a memory model, interrupts, and other architectural features. The block-based processor includes a plurality of processing cores 110, including a processor core 111.

As shown in FIG. 1, the processor cores are connected to each other via core interconnect 120. The core interconnect 120 carries data and control signals between individual ones of the cores 110, a memory interface 140, and an input/output (I/O) interface 145. The core interconnect 120 can transmit and receive signals using electrical, optical, magnetic, or other suitable communication technology and can provide communication connections arranged according to a number of different topologies, depending on a particular desired configuration. For example, the core interconnect 120 can have a crossbar, a bus, a point-to-point bus, or other suitable topology. In some examples, any one of the cores 110 can be connected to any of the other cores, while in other examples, some cores are only connected to a subset of the other cores. For example, each core may only be connected to a nearest 4, 8, or 20 neighboring cores. The core interconnect 120 can be used to transmit input/output data to and from the cores, as well as transmit control signals and other information signals to and from the cores. For example, each of the cores 110 can receive and transmit semaphores that indicate the execution status of instructions currently being executed by each of the respective cores. In some examples, the core interconnect 120 is implemented as wires connecting the cores 110, and memory system, while in other examples, the core interconnect can include circuitry for multiplexing data signals on the interconnect wire(s), switch and/or routing components, including active signal drivers and repeaters, or other suitable circuitry. In some examples of the disclosed technology, signals transmitted within and to/from the processor 100 are not limited to full swing electrical digital signals, but the processor can be configured to include differential signals, pulsed signals, or other suitable signals for transmitting data and control signals.

In the example of FIG. 1, the memory interface 140 of the processor includes interface logic that is used to connect to additional memory, for example, memory located on another integrated circuit besides the processor 100. As shown in FIG. 1 an external memory system 150 includes an L2 cache 152 and main memory 155. In some examples the L2 cache can be implemented using static RAM (SRAM) and the main memory 155 can be implemented using dynamic RAM (DRAM). In some examples the memory system 150 is included on the same integrated circuit as the other components of the processor 100. In some examples, the memory interface 140 includes a direct memory access (DMA) controller allowing transfer of blocks of data in memory without using register file(s) and/or the processor 100. In some examples, the memory interface 140 can include a memory management unit (MMU) for managing and allocating virtual memory, expanding the available main memory 155.

The I/O interface 145 includes circuitry for receiving and sending input and output signals to other components, such as hardware interrupts, system control signals, peripheral interfaces, co-processor control and/or data signals (e.g., signals for a graphics processing unit, floating point coprocessor, physics processing unit, digital signal processor, or other co-processing components), clock signals, semaphores, or other suitable I/O signals. The I/O signals may be synchronous or asynchronous. In some examples, all or a portion of the I/O interface is implemented using memory-mapped I/O techniques in conjunction with the memory interface 140.

The block-based processor 100 can also include a control unit 160. The control unit can communicate with the processing cores 110, the I/O interface 145, and the memory interface 140 via the core interconnect 120 or a side-band interconnect (not shown). The control unit 160 supervises operation of the processor 100. Operations that can be performed by the control unit 160 can include allocation and de-allocation of cores for performing instruction processing, control of input data and output data between any of the cores, register files, the memory interface 140, and/or the I/O interface 145, modification of execution flow, and verifying target location(s) of branch instructions, instruction headers, and other changes in control flow. The control unit 160 can also process hardware interrupts, and control reading and writing of special system registers, for example the program counter stored in one or more register file(s). In some examples of the disclosed technology, the control unit 160 is at least partially implemented using one or more of the processing cores 110, while in other examples, the control unit 160 is implemented using a non-block-based processing core (e.g., a general-purpose RISC processing core coupled to memory). In some examples, the control unit 160 is implemented at least in part using one or more of: hardwired finite state machines, programmable microcode, programmable gate arrays, or other suitable control circuits. In alternative examples, control unit functionality can be performed by one or more of the cores 110.

The control unit 160 includes a scheduler that is used to allocate instruction blocks to the processor cores 110. As used herein, scheduler allocation refers to hardware for directing operation of instruction blocks, including initiating instruction block mapping, fetching, decoding, execution, committing, aborting, idling, and refreshing an instruction block. In some examples, the hardware receives signals generated using computer-executable instructions to direct operation of the instruction scheduler. Processor cores 110 are assigned to instruction blocks during instruction block mapping. The recited stages of instruction operation are for illustrative purposes, and in some examples of the disclosed technology, certain operations can be combined, omitted, separated into multiple operations, or additional operations added.

The block-based processor 100 also includes a clock generator 170, which distributes one or more clock signals to various components within the processor (e.g., the cores 110, interconnect 120, memory interface 140, and I/O interface 145). In some examples of the disclosed technology, all of the components share a common clock, while in other examples different components use a different clock, for example, a clock signal having differing clock frequencies. In some examples, a portion of the clock is gated to allow power savings when some of the processor components are not in use. In some examples, the clock signals are generated using a phase-locked loop (PLL) to generate a signal of fixed, constant frequency and duty cycle. Circuitry that receives the clock signals can be triggered on a single edge (e.g., a rising edge) while in other examples, at least some of the receiving circuitry is triggered by rising and falling clock edges. In some examples, the clock signal can be transmitted optically or wirelessly.

### IV. Example Block-Based Processor Core

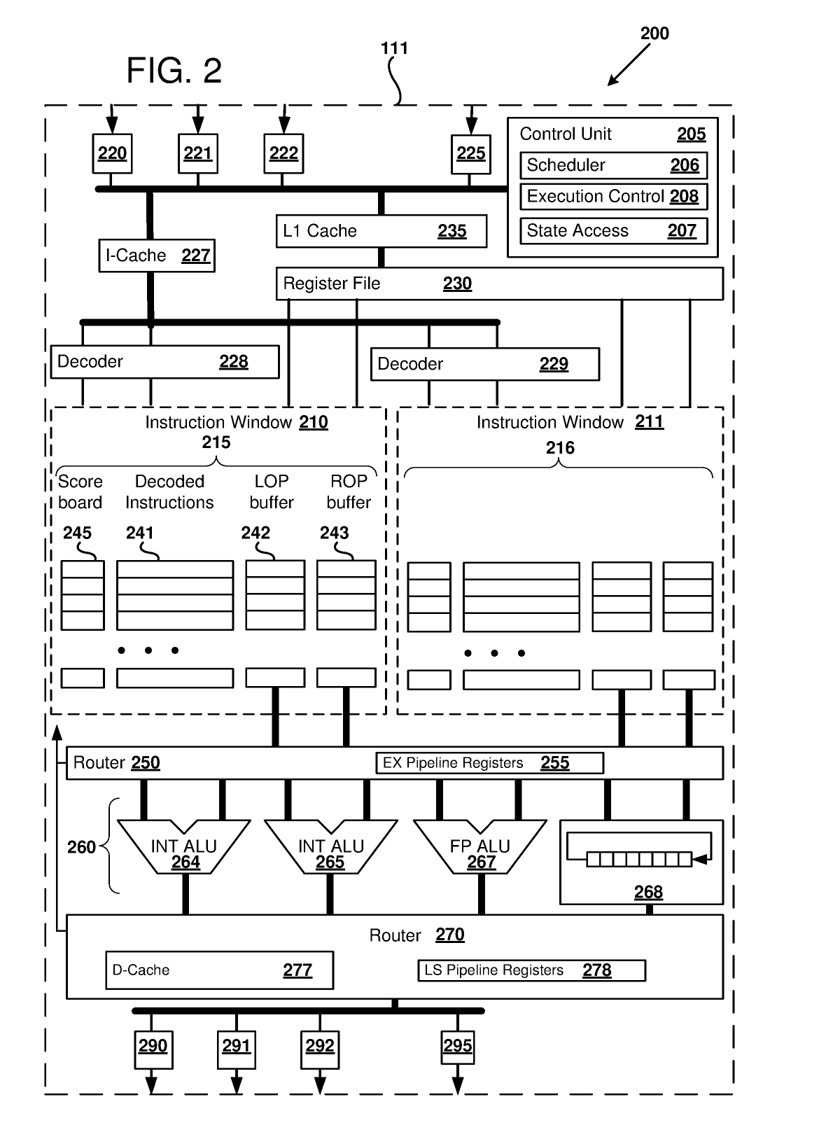

FIG. 2 is a block diagram 200 further detailing an example microarchitecture for the block-based processor 100, and in particular, an instance of one of the block-based processor cores (processor core 111), as can be used in certain examples of the disclosed technology. For ease of explanation, the exemplary block-based processor core 111 is illustrated with five stages: instruction fetch (IF), decode (DC), operand fetch, execute (EX), and memory/data access (LS). However, it will be readily understood by one of ordinary skill in the relevant art that modifications to the illustrated microarchitecture, such as adding/removing stages, adding/removing units that perform operations, and other implementation details can be modified to suit a particular application for a block-based processor.

In some examples of the disclosed technology, the processor core 111 can be used to execute and commit an instruction block of a program. An instruction block is an atomic collection of block-based-processor instructions that includes an instruction block header and a plurality of instructions. As will be discussed further below, the instruction block header can include information describing an execution mode of the instruction block and information that can be used to further define semantics of one or more of the plurality of instructions within the instruction block. Depending on the particular ISA and processor hardware used, the instruction block header can also be used, during execution of the instructions, to improve performance of executing an instruction block by, for example, allowing for early fetching of instructions and/or data, improved branch prediction, speculative execution, improved energy efficiency, and improved code compactness.

The instructions of the instruction block can be dataflow instructions that explicitly encode relationships between producer-consumer instructions of the instruction block. In particular, an instruction can communicate a result directly to a targeted instruction through an operand buffer that is reserved only for the targeted instruction. The intermediate results stored in the operand buffers are generally not visible to cores outside of the executing core because the block-atomic execution model only passes final results between the instruction blocks. The final results from executing the instructions of the atomic instruction block are made visible outside of the executing core when the instruction block is committed. Thus, the visible architectural state generated by each instruction block can appear as a single transaction outside of the executing core, and the intermediate results are typically not observable outside of the executing core.

As shown in FIG. 2, the processor core 111 includes a control unit 205, which can receive control signals from other cores and generate control signals to regulate core operation and schedules the flow of instructions within the core using an instruction scheduler 206. The control unit 205 can include state access logic 207 for examining core status and/or configuring operating modes of the processor core 111. The control unit 205 can include execution control logic 208 for generating control signals during one or more operating modes of the processor core 111. Operations that can be performed by the control unit 205 and/or instruction scheduler 206 can include allocation and de-allocation of cores for performing instruction processing, control of input data and output data between any of the cores, register files, the memory interface 140, and/or the I/O interface 145. The control unit 205 can also process hardware interrupts, and control reading and writing of special system registers, for example the program counter stored in one or more register file(s). In other examples of the disclosed technology, the control unit 205 and/or instruction scheduler 206 are implemented using a non-block-based processing core (e.g., a general-purpose RISC processing core coupled to memory). In some examples, the control unit 205, instruction scheduler 206, state access logic 207, and/or execution control logic 208 are implemented at least in part using one or more of: hardwired finite state machines, programmable microcode, programmable gate arrays, or other suitable control circuits.

The control unit 205 can decode the instruction block header to obtain information about the instruction block. For example, execution modes of the instruction block can be specified in the instruction block header though various execution flags. The decoded execution mode can be stored in registers of the execution control logic 208. Based on the execution mode, the execution control logic 208 can generate control signals to regulate core operation and schedule the flow of instructions within the core 111, such as by using the instruction scheduler 206. For example, during a default execution mode, the execution control logic 208 can sequence the instructions of one or more instruction blocks executing on one or more instruction windows (e.g., 210, 211) of the processor core 111. Specifically, each of the instructions can be sequenced through the instruction fetch, decode, operand fetch, execute, and memory/data access stages so that the instructions of an instruction block can be pipelined and executed in parallel. The instructions are ready to execute when their operands are available, and the instruction scheduler 206 can select the order in which to execute the instructions.

The state access logic 207 can include an interface for other cores and/or a processor-level control unit (such as the control unit 160 of FIG. 1) to communicate with and access state of the core 111. For example, the state access logic 207 can be connected to a core interconnect (such as the core interconnect 120 of FIG. 1) and the other cores can communicate via control signals, messages, reading and writing registers, and the like.

The state access logic 207 can include control state registers or other logic for modifying and/or examining modes and/or status of an instruction block and/or core status. As an example, the core status can indicate whether an instruction block is mapped to the core 111 or an instruction window (e.g., instruction windows 210, 211) of the core 111, whether an instruction block is resident on the core 111, whether an instruction block is executing on the core 111, whether the instruction block is ready to commit, whether the instruction block is performing a commit, and whether the instruction block is idle. As another example, the status of an instruction block can include a token or flag indicating the instruction block is the oldest instruction block executing and a flag indicating the instruction block is executing speculatively.

The control state registers (CSRs) can be mapped to unique memory locations that are reserved for use by the block-based processor. For example, CSRs of the control unit 160 (FIG. 1) can be assigned to a first range of addresses, CSRs of the memory interface 140 (FIG. 1) can be assigned to a second range of addresses, a first processor core can be assigned to a third range of addresses, a second processor core can be assigned to a fourth range of addresses, and so forth. In one embodiment, the CSRs can be accessed using general purpose memory read and write instructions of the block-based processor. Additionally or alternatively, the CSRs can be accessed using specific read and write instructions (e.g., the instructions have opcodes different from the memory read and write instructions) for the CSRs. Thus, one core can examine the configuration state of a different core by reading from an address corresponding to the different core's CSRs. Similarly, one core can modify the configuration state of a different core by writing to an address corresponding to the different core's CSRs. Additionally or alternatively, the CSRs can be accessed by shifting commands into the state access logic 207 through serial scan chains. In this manner, one core can examine the state access logic 207 of a different core and one core can modify the state access logic 207 or modes of a different core.

Each of the instruction windows 210 and 211 can receive instructions and data from one or more of input ports 220, 221, and 222 which connect to an interconnect bus and instruction cache 227, which in turn is connected to the instruction decoders 228 and 229. Additional control signals can also be received on an additional input port 225. Each of the instruction decoders 228 and 229 decodes instructions for an instruction block and stores the decoded instructions within a memory store 215 and 216 located in each respective instruction window 210 and 211.

The processor core 111 further includes a register file 230 coupled to an L1 (level one) cache 235. The register file 230 stores data for registers defined in the block-based processor architecture, and can have one or more read ports and one or more write ports. For example, a register file may include two or more write ports for storing data in the register file, as well as having a plurality of read ports for reading data from individual registers within the register file. In some examples, a single instruction window (e.g., instruction window 210) can access only one port of the register file at a time, while in other examples, the instruction window 210 can access one read port and one write port, or can access two or more read ports and/or write ports simultaneously. In some examples, the register file 230 can include 64 registers, each of the registers holding a word of 32 bits of data. (This application will refer to 32-bits of data as a word, unless otherwise specified.) In some examples, some of the registers within the register file 230 may be allocated to special purposes. For example, some of the registers can be dedicated as system registers examples of which include registers storing constant values (e.g., an all zero word), program counter(s) (PC), which indicate the current address of a program thread that is being executed, a physical core number, a logical core number, a core assignment topology, core control flags, a processor topology, or other suitable dedicated purpose. In some examples, there are multiple program counter registers, one or each program counter, to allow for concurrent execution of multiple execution threads across one or more processor cores and/or processors. In some examples, program counters are implemented as designated memory locations instead of as registers in a register file. In some examples, use of the system registers may be restricted by the operating system or other supervisory computer instructions. In some examples, the register file 230 is implemented as an array of flip-flops, while in other examples, the register file can be implemented using latches, SRAM, or other forms of memory storage. The ISA specification for a given processor, for example processor 100, specifies how registers within the register file 230 are defined and used.

In some examples, the processor 100 includes a global register file that is shared by a plurality of the processor cores. In some examples, individual register files associated with a processor core can be combined to form a larger file, statically or dynamically, depending on the processor ISA and configuration.

As shown in FIG. 2, the memory store 215 of the instruction window 210 includes a number of decoded instructions 241, a left operand (LOP) buffer 242, a right operand (ROP) buffer 243, and an instruction scoreboard 245. In some examples of the disclosed technology, each instruction of the instruction block is decomposed into a row of decoded instructions, left and right operands, and scoreboard data, as shown in FIG. 2. The decoded instructions 241 can include partially- or fully-decoded versions of instructions stored as bit-level control signals. The operand buffers 242 and 243 store operands (e.g., register values received from the register file 230, data received from memory, immediate operands coded within an instruction, operands calculated by an earlier-issued instruction, or other operand values) until their respective decoded instructions are ready to execute. Instruction operands are read from the operand buffers 242 and 243, not the register file.

The memory store 216 of the second instruction window 211 stores similar instruction information (decoded instructions, operands, and scoreboard) as the memory store 215, but is not shown in FIG. 2 for the sake of simplicity. Instruction blocks can be executed by the second instruction window 211 concurrently or sequentially with respect to the first instruction window, subject to ISA constraints and as directed by the control unit 205.

In some examples of the disclosed technology, front-end pipeline stages IF and DC can run decoupled from the back-end pipelines stages (IS, EX, LS). In one embodiment, the control unit can fetch and decode two instructions per clock cycle into each of the instruction windows 210 and 211. In alternative embodiments, the control unit can fetch and decode one, four, or another number of instructions per clock cycle into a corresponding number of instruction windows. The control unit 205 provides instruction window dataflow scheduling logic to monitor the ready state of each decoded instruction's inputs (e.g., each respective instruction's predicate(s) and operand(s) using the scoreboard 245. When all of the inputs for a particular decoded instruction are ready, the instruction is ready to issue. The control logic 205 then initiates execution of one or more next instruction(s) (e.g., the lowest numbered ready instruction) each cycle and its decoded instruction and input operands are sent to one or more of functional units 260 for execution. The decoded instruction can also encode a number of ready events. The scheduler in the control logic 205 accepts these and/or events from other sources and updates the ready state of other instructions in the window. Thus execution proceeds, starting with the processor core's 111 ready zero input instructions, instructions that are targeted by the zero input instructions, and so forth.

The decoded instructions 241 need not execute in the same order in which they are arranged within the memory store 215 of the instruction window 210. Rather, the instruction scoreboard 245 is used to track dependencies of the decoded instructions and, when the dependencies have been met, the associated individual decoded instruction is scheduled for execution. For example, a reference to a respective instruction can be pushed onto a ready queue when the dependencies have been met for the respective instruction, and instructions can be scheduled in a first-in first-out (FIFO) order from the ready queue. Information stored in the scoreboard 245 can include, but is not limited to, the associated instruction's execution predicate (such as whether the instruction is waiting for a predicate bit to be calculated and whether the instruction executes if the predicate bit is true or false), availability of operands to the instruction, or other prerequisites required before executing the associated individual instruction.

In one embodiment, the scoreboard 245 can include decoded ready state, which is initialized by the instruction decoder 228, and active ready state, which is initialized by the control unit 205 during execution of the instructions. For example, the decoded ready state can encode whether a respective instruction has been decoded, awaits a predicate and/or some operand(s), perhaps via a broadcast channel, or is immediately ready to issue. The active ready state can encode whether a respective instruction awaits a predicate and/or some operand(s), is ready to issue, or has already issued. The decoded ready state can cleared on a block reset or a block refresh. Upon branching to a new instruction block, the decoded ready state and the active ready state is cleared (a block or core reset). However, when an instruction block is re-executed on the core, such as when it branches back to itself (a block refresh), only active ready state is cleared. Block refreshes can occur immediately (when an instruction block branches to itself) or after executing a number of other intervening instruction blocks. The decoded ready state for the instruction block can thus be preserved so that it is not necessary to re-fetch and decode the block's instructions. Hence, block refresh can be used to save time and energy in loops and other repeating program structures.

The number of instructions that are stored in each instruction window generally corresponds to the number of instructions within an instruction block. In some examples, the number of instructions within an instruction block can be 32, 64, 128, 1024, or another number of instructions. In some examples of the disclosed technology, an instruction block is allocated across multiple instruction windows within a processor core. In some examples, the instruction windows 210, 211 can be logically partitioned so that multiple instruction blocks can be executed on a single processor core. For example, one, two, four, or another number of instruction blocks can be executed on one core. The respective instruction blocks can be executed concurrently or sequentially with each other.

Instructions can be allocated and scheduled using the control unit 205 located within the processor core 111. The control unit 205 orchestrates fetching of instructions from memory, decoding of the instructions, execution of instructions once they have been loaded into a respective instruction window, data flow into/out of the processor core 111, and control signals input and output by the processor core. For example, the control unit 205 can include the ready queue, as described above, for use in scheduling instructions. The instructions stored in the memory store 215 and 216 located in each respective instruction window 210 and 211 can be executed atomically. Thus, updates to the visible architectural state (such as writes to the register file 230) affected by the executed instructions can be buffered locally within the core until the instructions are committed. The control unit 205 can determine when instructions are ready to be committed, sequence the commit logic, and issue a commit signal. For example, a commit phase for an instruction block can begin when all register writes are buffered, all writes to memory are buffered, and a branch target is calculated. The instruction block can be committed when updates to the visible architectural state are complete. For example, an instruction block can be committed when the register writes are written to the register file, the stores are sent to a memory controller, and the commit signal is generated. The control unit 205 also controls, at least in part, allocation of functional units 260 to each of the respective instructions windows.

As shown in FIG. 2, a first router 250, which has a number of execution pipeline registers 255, is used to send data from either of the instruction windows 210 and 211 to one or more of the functional units 260, which can include but are not limited to, integer ALUs (arithmetic logic units) (e.g., integer ALUs 264 and 265), floating point units (e.g., floating point ALU 267), shift/rotate logic (e.g., barrel shifter 268), or other suitable execution units, which can including graphics functions, physics functions, and other mathematical operations. Data from the functional units 260 can then be routed through a second router 270 to outputs 290, 291, and 292, routed back to an operand buffer (e.g. LOP buffer 242 and/or ROP buffer 243), or fed back to another functional unit, depending on the requirements of the particular instruction being executed. The second router 270 can include a data cache 277, which stores data being output from the core to memory, and load-store pipeline register 278.

The core also includes control outputs 295 which are used to indicate, for example, when execution of all of the instructions for one or more of the instruction windows 210 or 211 has completed. When execution of an instruction block is complete, the instruction block is designated as “committed” and signals from the control outputs 295 can in turn can be used by other cores within the block-based processor 100 and/or by the control unit 160 to initiate scheduling, fetching, and execution of other instruction blocks. Both the first router 250 and the second router 270 can send data back to the instruction (for example, as operands for other instructions within an instruction block).

As will be readily understood to one of ordinary skill in the relevant art, the components within an individual core are not limited to those shown in FIG. 2, but can be varied according to the requirements of a particular application. For example, a core may have fewer or more instruction windows, a single instruction decoder might be shared by two or more instruction windows, and the number of and type of functional units used can be varied, depending on the particular targeted application for the block-based processor. Other considerations that apply in selecting and allocating resources with an instruction core include performance requirements, energy usage requirements, integrated circuit die, process technology, and/or cost.

It will be readily apparent to one of ordinary skill in the relevant art that trade-offs can be made in processor performance by the design and allocation of resources within the instruction window (e.g., instruction window 210) and control logic 205 of the processor cores 110. The area, clock period, capabilities, and limitations substantially determine the realized performance of the individual cores 110 and the throughput of the block-based processor cores 110.

The instruction scheduler 206 can have diverse functionality. In certain higher performance examples, the instruction scheduler is highly concurrent. For example, each cycle, the decoder(s) write instructions' decoded ready state and decoded instructions into one or more instruction windows, selects the next instruction to issue, and, in response the back end sends ready events—either target-ready events targeting a specific instruction's input slot (predicate, left operand, right operand, etc.), or broadcast-ready events targeting all instructions. The per-instruction ready state bits, together with the decoded ready state can be used to determine that the instruction is ready to issue.

In some examples, the instruction scheduler 206 is implemented using storage (e.g., first-in first-out (FIFO) queues, content addressable memories (CAMs)) storing data indicating information used to schedule execution of instruction blocks according to the disclosed technology. For example, data regarding instruction dependencies, transfers of control, speculation, branch prediction, and/or data loads and stores are arranged in storage to facilitate determinations in mapping instruction blocks to processor cores. For example, instruction block dependencies can be associated with a tag that is stored in a FIFO or CAM and later accessed by selection logic used to map instruction blocks to one or more processor cores. In some examples, the instruction scheduler 206 is implemented using a general purpose processor coupled to memory, the memory being configured to store data for scheduling instruction blocks. In some examples, instruction scheduler 206 is implemented using a special purpose processor or using a block-based processor core coupled to the memory. In some examples, the instruction scheduler 206 is implemented as a finite state machine coupled to the memory. In some examples, an operating system executing on a processor (e.g., a general purpose processor or a block-based processor core) generates priorities, predictions, and other data that can be used at least in part to schedule instruction blocks with the instruction scheduler 206. As will be readily apparent to one of ordinary skill in the relevant art, other circuit structures, implemented in an integrated circuit, programmable logic, or other suitable logic can be used to implement hardware for the instruction scheduler 206.

In some cases, the scheduler 206 accepts events for target instructions that have not yet been decoded and must also inhibit reissue of issued ready instructions. Instructions can be non-predicated, or predicated (based on a true or false condition). A predicated instruction does not become ready until it is targeted by another instruction's predicate result, and that result matches the predicate condition. If the associated predicate does not match, the instruction never issues. In some examples, predicated instructions may be issued and executed speculatively. In some examples, a processor may subsequently check that speculatively issued and executed instructions were correctly speculated. In some examples a misspeculated issued instruction and the specific transitive closure of instructions in the block that consume its outputs may be re-executed, or misspeculated side effects annulled. In some examples, discovery of a misspeculated instruction leads to the complete roll back and re-execution of an entire block of instructions.

### V. Example Stream of Instruction Blocks

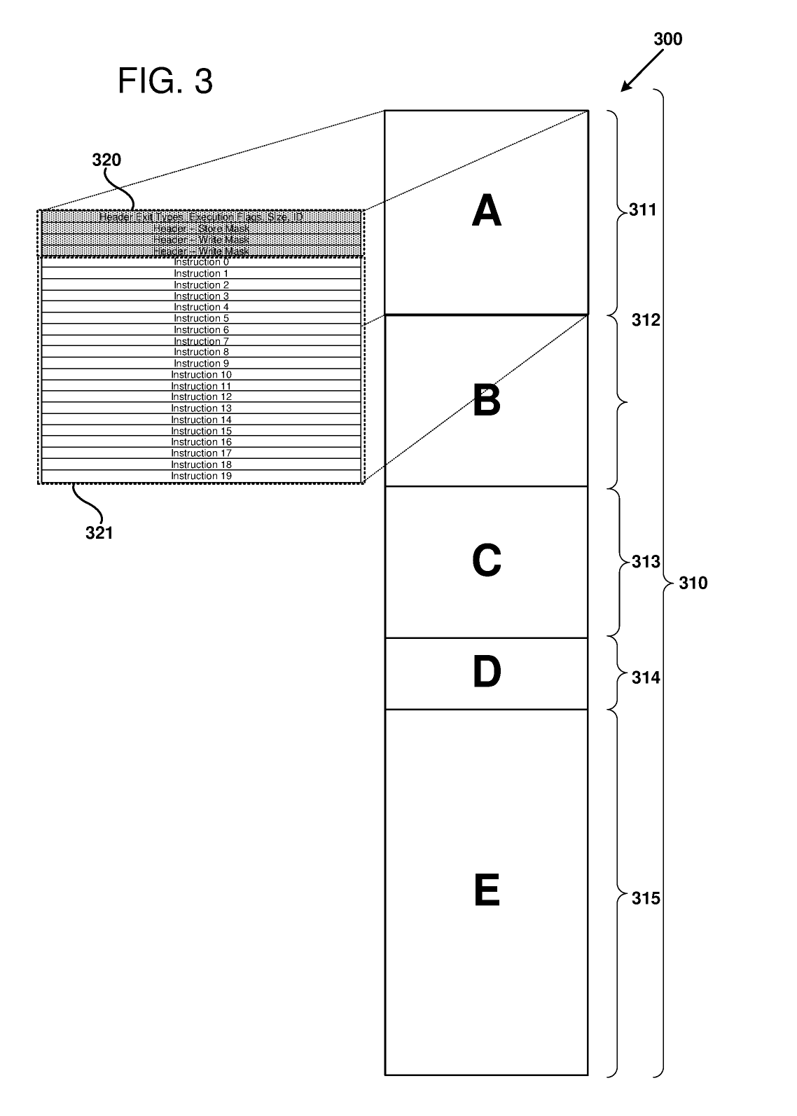

Turning now to the diagram 300 of FIG. 3, a portion 310 of a stream of block-based instructions, including a number of variable length instruction blocks 311-315 (A-E) is illustrated. The stream of instructions can be used to implement user application, system services, or any other suitable use. In the example shown in FIG. 3, each instruction block begins with an instruction header, which is followed by a varying number of instructions. For example, the instruction block 311 includes a header 320 and twenty instructions 321. The particular instruction header 320 illustrated includes a number of data fields that control, in part, execution of the instructions within the instruction block, and also allow for improved performance enhancement techniques including, for example branch prediction, speculative execution, lazy evaluation, and/or other techniques. The instruction header 320 also includes an ID bit which indicates that the header is an instruction header and not an instruction. The instruction header 320 also includes an indication of the instruction block size. The instruction block size can be in larger chunks of instructions than one, for example, the number of 4-instruction chunks contained within the instruction block. In other words, the size of the block is shifted 4 bits in order to compress header space allocated to specifying instruction block size. Thus, a size value of 0 indicates a minimally-sized instruction block which is a block header followed by four instructions. In some examples, the instruction block size is expressed as a number of bytes, as a number of words, as a number of n-word chunks, as an address, as an address offset, or using other suitable expressions for describing the size of instruction blocks. In some examples, the instruction block size is indicated by a terminating bit pattern in the instruction block header and/or footer.

The instruction block header 320 can also include execution flags, which indicate special instruction execution requirements. For example, branch prediction or memory dependence prediction can be inhibited for certain instruction blocks, depending on the particular application.

In some examples of the disclosed technology, the instruction header 320 includes one or more identification bits that indicate that the encoded data is an instruction header. For example, in some block-based processor ISAs, a single ID bit in the least significant bit space is always set to the binary value 1 to indicate the beginning of a valid instruction block. In other examples, different bit encodings can be used for the identification bit(s). In some examples, the instruction header 320 includes information indicating a particular version of the ISA for which the associated instruction block is encoded.

The block instruction header can also include a number of block exit types for use in, for example, branch prediction, control flow determination, and/or bad jump detection. The exit type can indicate what the type of branch instructions are, for example: sequential branch instructions, which point to the next contiguous instruction block in memory; offset instructions, which are branches to another instruction block at a memory address calculated relative to an offset; subroutine calls, or subroutine returns. By encoding the branch exit types in the instruction header, the branch predictor can begin operation, at least partially, before branch instructions within the same instruction block have been fetched and/or decoded.

The instruction block header 320 also includes a store mask which identifies the load-store identifiers that are assigned to store operations for the instruction block. The instruction block header can also include a write mask, which identifies which global register(s) the associated instruction block will write. The associated register file must receive a write to each entry before the instruction block can complete. In some examples a block-based processor architecture can include not only scalar instructions, but also single-instruction multiple-data (SIMD) instructions, that allow for operations with a larger number of data operands within a single instruction.

### VI. Example Block Instruction Target Encoding

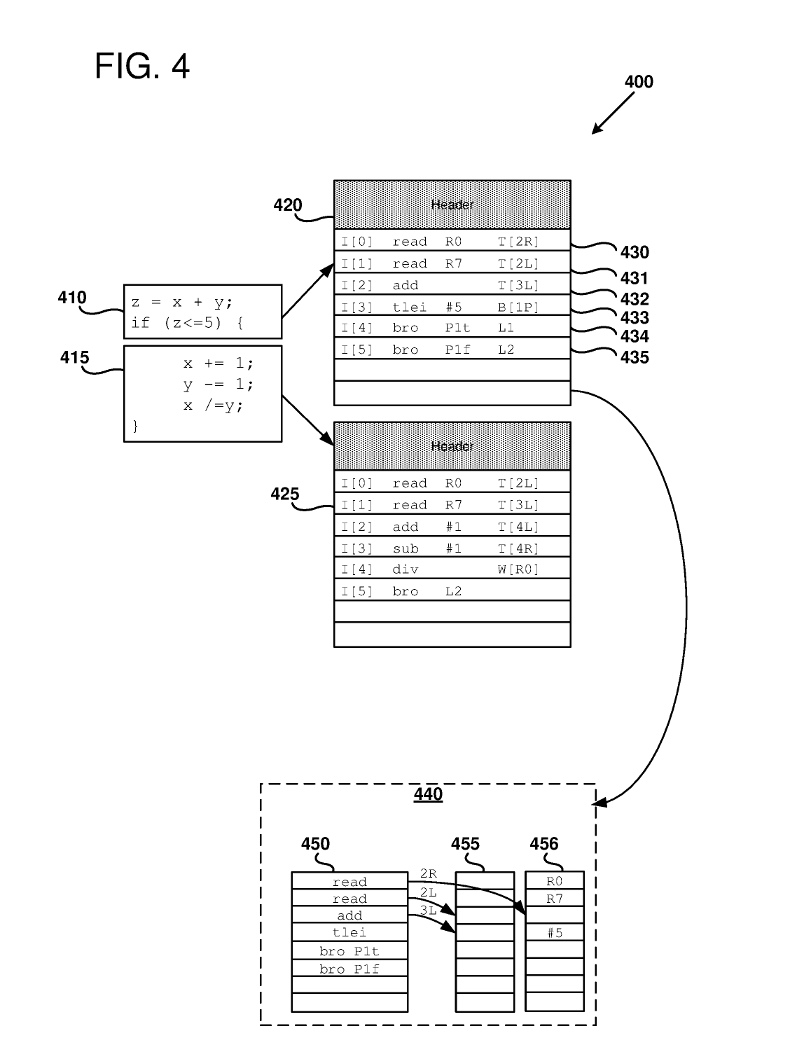

FIG. 4 is a diagram 400 depicting an example of two portions 410 and 415 of C language source code and their respective instruction blocks 420 and 425 (in assembly language), illustrating how block-based instructions can explicitly encode their targets. The high-level C language source code can be translated to the low-level assembly language and machine code by a compiler whose target is a block-based processor. A high-level language can abstract out many of the details of the underlying computer architecture so that a programmer can focus on functionality of the program. In contrast, the machine code encodes the program according to the target computer's ISA so that it can be executed on the target computer, using the computer's hardware resources. Assembly language is a human-readable form of machine code.

In the following examples, the assembly language instructions use the following nomenclature: “[<IID>] specifies the instruction identifier (IID) of the instruction within the instruction block where the instruction identifiers begin at zero for the instruction following the instruction header and the instruction identifiers are incremented for each successive instruction; the operation of the instruction (such as READ, ADDI, DIV, and the like) follows the instruction identifier; optional values (such as the immediate value 1) or references to registers (such as R0 for register 0) follow the operation; and optional targets that are to receive the results of the instruction follow the values and/or operation. Each of the targets can be to another instruction, a broadcast channel to other instructions, or a register that can be visible to another instruction block when the instruction block is committed. An example of an instruction target is T[1R] which targets the right operand of the instruction having an IID=1. An example of a register target is W[R0], where the target is written to register 0.

In the diagram 400, the first two READ instructions 430 and 431 of the instruction block 420 target the right (T[2R]) and left (T[2L]) operands, respectively, of the ADD instruction 432 having an IID=2. In the illustrated ISA, the read instructions are the only instructions that read from the global register file; however any instruction can target, the global register file. When the ADD instruction 432 receives the result of both register reads it will become ready and execute.

When the TLEI (test-less-than-equal-immediate) instruction 433 receives its single input operand from the ADD, it will become ready and execute. The test then produces a predicate operand that is broadcast on channel one (B[1P]) to all instructions listening on the broadcast channel, which in this example are the two predicated branch instructions (BRO Plt 434 and BRO Plf 435). In the assembly language of the diagram 400, “P1f” indicates the instruction is predicated (the “P”) on a false result (the “f”) being transmitted on broadcast channel 1 (the “1”), and “Plt” indicates the instruction is predicated on a true result being transmitted on broadcast channel 1. The branch that receives a matching predicate will fire.

A dependence graph 440 for the instruction block 420 is also illustrated, as an array 450 of instruction nodes and their corresponding operand targets 455 and 456. This illustrates the correspondence between the block instructions 420, the corresponding instruction window entries, and the underlying dataflow graph represented by the instructions. Here decoded instructions READ 430 and READ 431 are ready to issue, as they have no input dependencies. As they issue and execute, the values read from registers R6 and R7 are written into the right and left operand buffers of ADD 432, marking the left and right operands of ADD 432 “ready.” As a result, the ADD 432 instruction becomes ready, issues to an ALU, executes, and the sum is written to the left operand of TLEI 433.

As a comparison, a conventional out-of-order RISC or CISC processor would dynamically build the dependence graph at runtime, using additional hardware complexity, power, area and reducing clock frequency and performance. However, the dependence graph is known statically at compile time and an EDGE compiler can directly encode the producer-consumer relations between the instructions through the ISA, freeing the microarchitecture from rediscovering them dynamically. This can potentially enable a simpler microarchitecture, reducing area, power and boosting frequency and performance.

### VII. Example Block-Based Instruction Formats

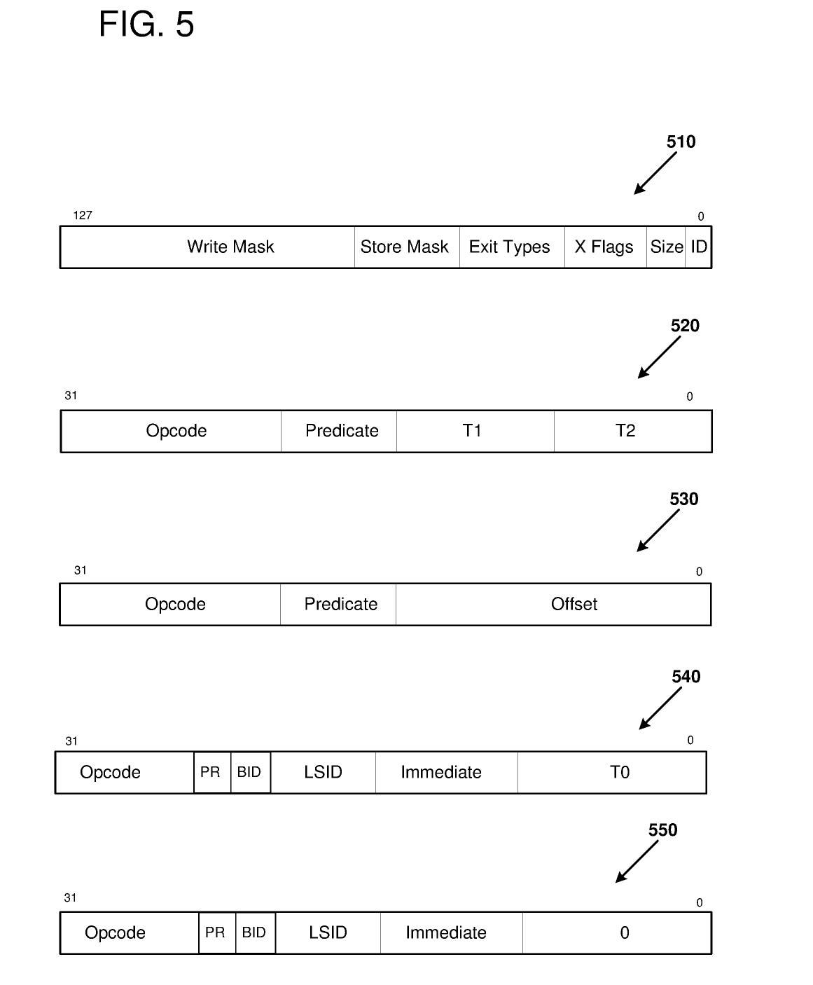

FIG. 5 is a diagram illustrating generalized examples of instruction formats for an instruction header 510, a generic instruction 520, a branch instruction 530, a load instruction 540, and a store instruction 550. Each of the instruction headers or instructions is labeled according to the number of bits. For example, the instruction header 510 includes four 32-bit words and is labeled from its least significant bit (lsb) (bit 0) up to its most significant bit (msb) (bit 127). As shown, the instruction header includes a write mask field, a store mask field, a number of exit type fields, a number of execution flag fields (X flags), an instruction block size field, and an instruction header ID bit (the least significant bit of the instruction header).

The execution flag fields can indicate special instruction execution modes. For example, an “inhibit branch predictor” flag can be used to inhibit branch prediction for the instruction block when the flag is set. As another example, an “inhibit memory dependence prediction” flag can be used to inhibit memory dependence prediction for the instruction block when the flag is set. As another example, a “break after block” flag can be used to halt an instruction thread and raise an interrupt when the instruction block is committed. As another example, a “break before block” flag can be used to halt an instruction thread and raise an interrupt when the instruction block header is decoded and before the instructions of the instruction block are executed.

The exit type fields include data that can be used to indicate the types of control flow and/or synchronization instructions encoded within the instruction block. For example, the exit type fields can indicate that the instruction block includes one or more of the following: sequential branch instructions, offset branch instructions, indirect branch instructions, call instructions, return instructions, and/or break instructions. In some examples, the branch instructions can be any control flow instructions for transferring control flow between instruction blocks, including relative and/or absolute addresses, and using a conditional or unconditional predicate. The exit type fields can be used for branch prediction and speculative execution in addition to determining implicit control flow instructions. In some examples, up to six exit types can be encoded in the exit type fields, and the correspondence between fields and corresponding explicit or implicit control flow instructions can be determined by, for example, examining control flow instructions in the instruction block.

The illustrated generic block instruction 520 is stored as one 32-bit word and includes an opcode field, a predicate field, a broadcast ID field (BID), a first target field (T1), and a second target field (T2). For instructions with more consumers than target fields, a compiler can build a fanout tree using move instructions, or it can assign high-fanout instructions to broadcasts. Broadcasts support sending an operand over a lightweight network to any number of consumer instructions in a core. A broadcast identifier can be encoded in the generic block instruction 520.

While the generic instruction format outlined by the generic instruction 520 can represent some or all instructions processed by a block-based processor, it will be readily understood by one of skill in the art that, even for a particular example of an ISA, one or more of the instruction fields may deviate from the generic format for particular instructions. The opcode field specifies the length or width of the instruction 520 and the operation(s) performed by the instruction 520, such as memory load/store, register read/write, add, subtract, multiply, divide, shift, rotate, nullify, system operations, or other suitable instructions.

The predicate field specifies the condition under which the instruction will execute. For example, the predicate field can specify the value “true,” and the instruction will only execute if a corresponding condition flag matches the specified predicate value. In some examples, the predicate field specifies, at least in part, a field, operand, or other resource which is used to compare the predicate, while in other examples, the execution is predicated on a flag set by a previous instruction (e.g., the preceding instruction in the instruction block). In some examples, the predicate field can specify that the instruction will always, or never, be executed. Thus, use of the predicate field can allow for denser object code, improved energy efficiency, and improved processor performance, by reducing the number of branch instructions.

The target fields T1 and T2 specifying the instructions to which the results of the block-based instruction are sent. For example, an ADD instruction at instruction slot 5 can specify that its computed result will be sent to instructions at slots 3 and 10. Depending on the particular instruction and ISA, one or both of the illustrated target fields can be replaced by other information, for example, the first target field T1 can be replaced by an immediate operand, an additional opcode, specify two targets, etc.

The branch instruction 530 includes an opcode field, a predicate field, a broadcast ID field (BID), and an offset field. The opcode and predicate fields are similar in format and function as described regarding the generic instruction. The offset can be expressed in units of four instructions, thus extending the memory address range over which a branch can be executed. The predicate shown with the generic instruction 520 and the branch instruction 530 can be used to avoid additional branching within an instruction block. For example, execution of a particular instruction can be predicated on the result of a previous instruction (e.g., a comparison of two operands). If the predicate is false, the instruction will not commit values calculated by the particular instruction. If the predicate value does not match the required predicate, the instruction does not issue. For example, a BRO_F (predicated false) instruction will issue if it is sent a false predicate value.

It should be readily understood that, as used herein, the term “branch instruction” is not limited to changing program execution to a relative memory location, but also includes jumps to an absolute or symbolic memory location, subroutine calls and returns, and other instructions that can modify the execution flow. In some examples, the execution flow is modified by changing the value of a system register (e.g., a program counter PC or instruction pointer), while in other examples, the execution flow can be changed by modifying a value stored at a designated location in memory. In some examples, a jump register branch instruction is used to jump to a memory location stored in a register. In some examples, subroutine calls and returns are implemented using jump and link and jump register instructions, respectively.

The load instruction 540 is used for retrieving data stored at a target address of memory so that the data can be used by a processor core. The target address of the data can be calculated dynamically at runtime. For example, the address can be a sum of an operand of the load instruction 540 and an immediate field of the load instruction 540. As another example, the address can be a sum of an operand of the load instruction 540 and a sign-extended and/or shifted immediate field of the load instruction 540. As another example, the address of the data can be a sum of two operands of the load instruction 540. The load instruction 540 can include a load-store identifier field (LSID) to provide a relative program ordering of the load within an instruction block. In particular, the LSID can provide a relative position of the load instruction with respect to the other load and store instructions of the instruction block so that the programmed sequence of memory operations can be identified at run-time. For example, the compiler can assign an LSID to each load and store of the instruction block at compile-time. In one embodiment, the compiler can explicitly encode the LSID within a field of the load instruction 540. In an alternative embodiment, the compiler can implicitly encode the LSID of the load instruction 540 based on an order that the load and store instructions are emitted. For example, the first emitted load or store instruction can be assigned an LSID=0, the second emitted load or store instruction can be assigned an LSID=1, and so forth. In another alternative embodiment, the compiler can encode the LSIDs of the load and store instructions in a header of the instruction block. For example, the header can include a field that maps LSIDs to IIDs. The amount and type of data can be retrieved and/or formatted in various ways. For example, the data can be formatted as a signed or unsigned value and the amount or size of the data retrieved can vary. Different opcodes can be used to identify the type of load instruction 540, such as as a load unsigned byte, load signed byte, load double-word, load unsigned half-word, load signed half-word, load unsigned word, and load signed word, for example. The output of the load instruction 540 can be directed to a target instruction as indicated by a target field (T0).

A predicated load instruction is a load instruction that conditionally executes based on whether a result associated with the instruction matches a predicate test value. For example, the result can be delivered to an operand of the predicated load instruction from another instruction, and the predicate test value can be encoded in a field of the predicated load instruction. As a specific example, the load instruction 540 can be a predicated load instruction when one or more bits of the predicate field (PR) are non-zero. For example, the predicate field can be two bits wide where one bit is used to indicate that the instruction is predicated and one bit is used to indicate the predicate test value. Specifically, the encodings “00” can indicate the load instruction 540 is not predicated; “10” can indicate the load instruction 540 is predicated on a false condition (e.g., the predicate test value is a “0”); “11” can indicate the load instruction 540 is predicated on a true condition (e.g., the predicate test value is a “0”); and “10” can be reserved. Thus, a two-bit predicate field can be used to compare a received result to a true or false condition. A wider predicate field can be used to compare the received result to a larger number.

In one example, the result to be compared to the predicate test value can be passed to the instruction via one or more broadcast operands or channels. The broadcast channel of the predicate can be identified within the load instruction 540 using a broadcast identifier field (BID). For example, the broadcast identifier field can be two-bits wide to encode four possible broadcast channels on which to receive the value to compare to the predicate test value. As a specific example, if the value received on the identified broadcast channel matches the predicate test value, the load instruction 540 is executed. However, if the value received on the identified broadcast channel does not match the predicate test value, the load instruction 540 is not executed.

As a specific example of a 32-bit load instruction 540, the opcode field can be encoded in bits [31:25]; the predicate field can be encoded in bits [24:23]; the broadcast identifier field can be encoded in bits [22:21]; the LSID field can be encoded in bits [20:16]; the immediate field can be encoded in bits [15:9]; and the target field can be encoded in bits [8:0].

The store instruction 550 is used for storing data at a target address of the memory. The target address of the data can be calculated dynamically at runtime. For example, the address can be a sum of a first operand of the store instruction 550 and an immediate field of the store instruction 550. As another example, the address can be a sum of an operand of the store instruction 550 and a sign-extended and/or shifted immediate field of the store instruction 550. As another example, the address of the data can be a sum of two operands of the store instruction 550. The store instruction 550 can include a load-store identifier field (LSID) to provide a relative program ordering of the store within an instruction block. In particular, the LSID can provide a relative position of the store instruction with respect to the other load and store instructions of the instruction block so that the programmed sequence of memory operations can be identified at run-time. As described above with reference to the load instruction 540, the LSID can be explicitly encoded in a field of the store instruction 550, implicitly encoded based on an emitted order of the store instruction 550 within the instruction block, or encoded in a field (e.g., a LSID-IID mapping field) in a header of the instruction block. The amount of data to be stored can vary based on an opcode of the store instruction 550, such as a store byte, store half-word, store word, and store double-word, for example. The data to be stored at the memory location can be input from a second operand of the store instruction 550. The second operand can be generated by another instruction or encoded as a field of the store instruction 550.

A predicated store instruction is a store instruction that conditionally executes based on whether a result associated with the instruction matches a predicate test value. For example, the result can be delivered to an operand of the predicated store instruction from another instruction, and the predicate test value can be encoded in a field of the predicated store instruction. For example, the store instruction 550 can be a predicated store instruction when one or more bits of the predicate field (PR) are non-zero. The result to be compared to the predicate test value can be passed to the instruction via one or more broadcast operands or channels. The broadcast channel of the predicate can be identified within the store instruction 550 using a broadcast identifier field (BID). As a specific example, if the value received on the identified broadcast channel matches the predicate test value, the store instruction 550 is executed. However, if the value received on the identified broadcast channel does not match the predicate test value, the store instruction 550 is not executed.

As a specific example of a 32-bit store instruction 550, the opcode field can be encoded in bits [31:25]; the predicate field can be encoded in bits [24:23]; the broadcast identifier field can be encoded in bits [22:21]; the LSID field can be encoded in bits [20:16]; and the immediate field can be encoded in bits [15:9]. The bits [8:0] can be reserved for additional functions or for future use.

The use of predicated load and store instructions can lead to conditions where some of the load and store instructions are not executed. For example, a first group of instructions can be predicated on a true value and a second group of instructions can be predicated on a false value. Thus, only one of the groups of instructions can execute since a variable cannot be both true and false. The groups of instructions may include the same number (a balanced number) of load and store instructions or a different number (an unbalanced number) of load and store instructions. For example, the groups are unbalanced when the first group includes two load and store instructions and the second group includes six load and store instructions; the groups are balanced when the first and the second group each include two load and store instructions. The compiler can assign LSIDs to these instructions in various ways depending upon the functionality of the processor hardware. As one example, each load and store instruction within an instruction block can be assigned a unique LSID. As another example, a balanced number of load and store instructions along mutually exclusive paths can be assigned overlapping LSIDs. In other words, load and store instructions within an instruction block can share the same LSID if the load and store instructions are mutually exclusive. As a specific example, both a load instruction predicated on a true value and a load instruction predicated on a false value can be assigned the same LSID (e.g., LSID=1). Any unbalanced load and store instructions can be assigned unique LSIDs.

A nullify instruction can cancel a load or store instruction corresponding to a particular LSID or IID. In some processor embodiments, control logic of the processor may wait for an instruction with particular LSID to execute. For example, the processor may execute the load and store instructions in the sequential order matching the LSIDs and the control logic may wait to issue a load or store instruction until the preceding (as indicated by the LSID) load or store instruction executes. However, predicated load and store instructions with non-matching predicate values will not be executed. A nullify instruction can indicate that one or more load or store instructions will not be executed. In particular, the nullify instruction can be targeted toward one or more load or store instructions identified by their LSIDs or IIDs. Thus, the nullify instruction can be a substitute for executing a load or store instruction with a particular LSID or IID. For example, control logic waiting for a load or store instruction with the particular LSID can be triggered to perform an action by either the load or store instruction executing or being nullified.

As one example, the nullify instruction can be encoded using the format of the generic block instruction 520. The nullify instruction can be targeted toward load and store instructions that will not execute. When the non-executing load and store instructions receive a null operand from the nullify instruction, control logic can be updated as though the non-executing load and store instructions were executed. For example, alternative predicated paths can be unbalanced with two store instructions on one path (e.g., the true path) and three store instructions on the other path (e.g., the false path). The balanced store instructions can share LSIDs, and the unbalanced store instruction will have a unique LSID. The shorter path (the true path) can include a nullify instruction targeted to the unbalanced store instruction so that it appears to the control logic as if three store instructions are executed, regardless of which path is executed.

As a specific example of a 32-bit nullify instruction, the opcode field can be encoded in bits [31:25]; the predicate field can be encoded in bits [24:23]; the broadcast identifier field can be encoded in bits [22:21]; a first target field can be encoded in bits [17:9]; and a second target field can be encoded in bits [8:0]. Depending on the ISA, the target fields can target an instruction having a particular IID or LSID. The bits [20:18] can be reserved for additional functions or for future use. As another example, a bulk-nullify instruction can use a mask to nullify a group of load or store instructions in bulk using a bitmask to identify the nullified instructions. The bitmask can be encoded so that each bit of the bitmask corresponds to a different LSID. When an instruction block can include more LSIDs than can be supported by a single bitmask field of a bulk-nullify instruction, the bulk-nullify instruction can include a mask shift field that can be used to shift the bitmask over the full range of the LSIDs. For example a two-bit mask shift field and an eight-bit bitmask can be used to cover a range of 32 LSIDs. In particular, each instruction can nullify eight LSIDs and four different instructions can nullify all 32 LSIDs, where each instruction uses a different value in the mask shift field. As a specific example of a 32-bit bulk-nullify instruction, the opcode field can be encoded in bits [31:25]; the predicate field can be encoded in bits [24:23]; the broadcast identifier field can be encoded in bits [22:21]; a mask shift field can be encoded in bits [9:8]; and a mask field can be encoded in bits [7:0]. The bits [20:10] can be reserved for additional functions or for future use.

### VIII. Example States of a Processor Core

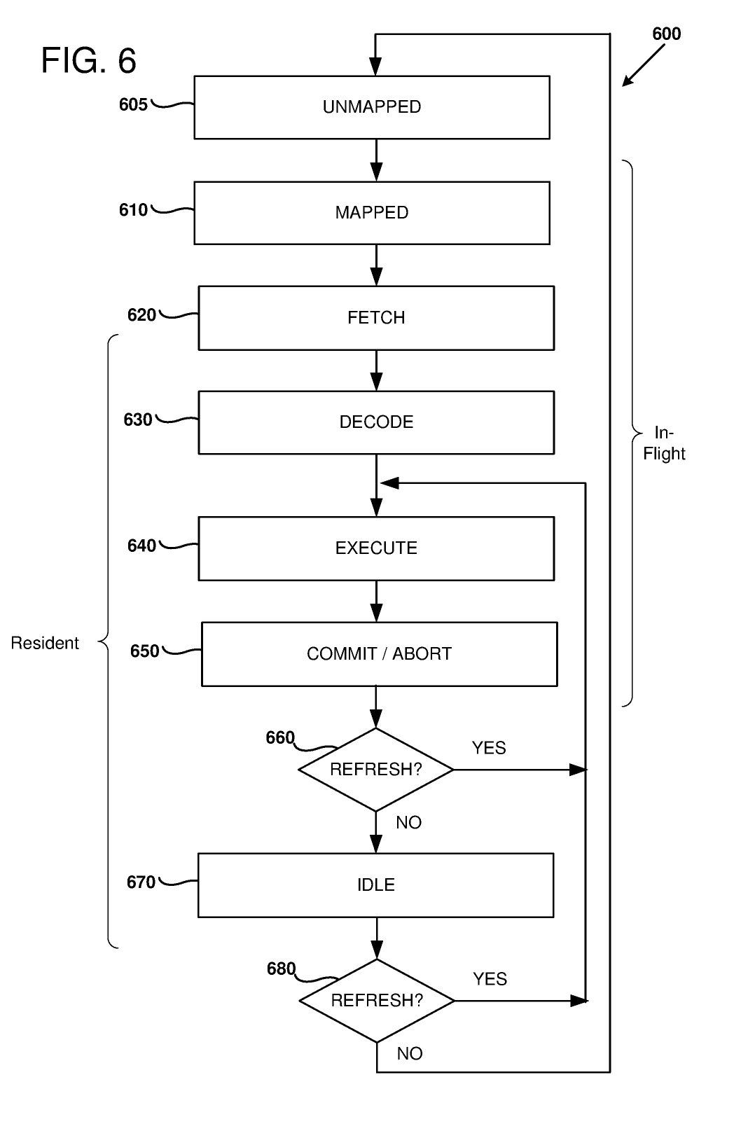

FIG. 6 is a flowchart illustrating an example of a progression of states 600 of a processor core of a block-based computer. The block-based computer is composed of multiple processor cores that are collectively used to run or execute a software program. The program can be written in a variety of high-level languages and then compiled for the block-based processor using a compiler that targets the block-based processor. The compiler can emit code that, when run or executed on the block-based processor, will perform the functionality specified by the high-level program. The compiled code can be stored in a computer-readable memory that can be accessed by the block-based processor. The compiled code can include a stream of instructions grouped into a series of instruction blocks. During execution, one or more of the instruction blocks can be executed by the block-based processor to perform the functionality of the program. Typically, the program will include more instruction blocks than can be executed on the cores at any one time. Thus, blocks of the program are mapped to respective cores, the cores perform the work specified by the blocks, and then the blocks on respective cores are replaced with different blocks until the program is complete. As one example, a single core can be used to execute all of the blocks of a program. Some of the instruction blocks may be executed more than once, such as during a loop or a subroutine of the program. An “instance” of an instruction block can be created for each time the instruction block will be executed. Thus, each repetition of an instruction block can use a different instance of the instruction block. As the program is run, the respective instruction blocks can be mapped to and executed on the processor cores based on architectural constraints, available hardware resources, and the dynamic flow of the program. During execution of the program, the respective processor cores can transition through a progression of states 600, so that one core can be in one state and another core can be in a different state.

At state 605, a state of a respective processor core can be unmapped. An unmapped processor core is a core that is not currently assigned to execute an instance of an instruction block. For example, the processor core can be unmapped before the program begins execution on the block-based computer. As another example, the processor core can be unmapped after the program begins executing but not all of the cores are being used. In particular, the instruction blocks of the program are executed, at least in part, according to the dynamic flow of the program. Some parts of the program may flow generally serially or sequentially, such as when a later instruction block depends on results from an earlier instruction block. Other parts of the program may have a more parallel flow, such as when multiple instruction blocks can execute at the same time without using the results of the other blocks executing in parallel. Fewer cores can be used to execute the program during more sequential streams of the program and more cores can be used to execute the program during more parallel streams of the program.

At state 610, the state of the respective processor core can be mapped. A mapped processor core is a core that is currently assigned to execute an instance of an instruction block. When the instruction block is mapped to a specific processor core, the instruction block is in-flight. An in-flight instruction block is a block that is targeted to a particular core of the block-based processor, and the block will be or is executing, either speculatively or non-speculatively, on the particular processor core. In particular, the in-flight instruction blocks correspond to the instruction blocks mapped to processor cores in states 610-650. A block executes non-speculatively when it is known during mapping of the block that the program will use the work provided by the executing instruction block. A block executes speculatively when it is not known during mapping whether the program will or will not use the work provided by the executing instruction block. Executing a block speculatively can potentially increase performance, such as when the speculative block is started earlier than if the block were to be started after or when it is known that the work of the block will be used. However, executing speculatively can potentially increase the energy used when executing the program, such as when the speculative work is not used by the program.

A block-based processor includes a finite number of homogeneous or heterogeneous processor cores. A typical program can include more instruction blocks than can fit onto the processor cores. Thus, the respective instruction blocks of a program will generally share the processor cores with the other instruction blocks of the program. In other words, a given core may execute the instructions of several different instruction blocks during the execution of a program. Having a finite number of processor cores also means that execution of the program may stall or be delayed when all of the processor cores are busy executing instruction blocks and no new cores are available for dispatch. When a processor core becomes available, an instance of an instruction block can be mapped to the processor core.

An instruction block scheduler can assign which instruction block will execute on which processor core and when the instruction block will be executed. The mapping can be based on a variety of factors, such as a target energy to be used for the execution, the number and configuration of the processor cores, the current and/or former usage of the processor cores, the dynamic flow of the program, whether speculative execution is enabled, a confidence level that a speculative block will be executed, and other factors. An instance of an instruction block can be mapped to a processor core that is currently available (such as when no instruction block is currently executing on it). In one embodiment, the instance of the instruction block can be mapped to a processor core that is currently busy (such as when the core is executing a different instance of an instruction block) and the later-mapped instance can begin when the earlier-mapped instance is complete.

At state 620, the state of the respective processor core can be fetch. For example, the IF pipeline stage of the processor core can be active during the fetch state. Fetching an instruction block can include transferring instructions of the block from memory (such as the L1 cache, the L2 cache, or main memory) to the processor core, and reading instructions from local buffers of the processor core so that the instructions can be decoded. For example, the instructions of the instruction block can be loaded into an instruction cache, buffer, or registers of the processor core. Multiple instructions of the instruction block can be fetched in parallel (e.g., at the same time) during the same clock cycle. The fetch state can be multiple cycles long and can overlap with the decode (630) and execute (640) states when the processor core is pipelined.

When instructions of the instruction block are loaded onto the processor core, the instruction block is resident on the processor core. The instruction block is partially resident when some, but not all, instructions of the instruction block are loaded. The instruction block is fully resident when all instructions of the instruction block are loaded. The instruction block will be resident on the processor core until the processor core is reset or a different instruction block is fetched onto the processor core. In particular, an instruction block is resident in the processor core when the core is in states 620-670.

At state 630, the state of the respective processor core can be decode. For example, the DC pipeline stage of the processor core can be active during the fetch state. During the decode state, instructions of the instruction block are being decoded so that they can be stored in the memory store of the instruction window of the processor core. In particular, the instructions can be transformed from relatively compact machine code, to a less compact representation that can be used to control hardware resources of the processor core. Predicated load and predicated store instructions can be identified during the decode state. The decode state can be multiple cycles long and can overlap with the fetch (620) and execute (640) states when the processor core is pipelined. After an instruction of the instruction block is decoded, it can be executed when all dependencies of the instruction are met.

At state 640, the state of the respective processor core can be execute. During the execute state, instructions of the instruction block are being executed. In particular, the EX and/or LS pipeline stages of the processor core can be active during the execute state. As described in more detail further below, the individual instructions of the instruction block can be scheduled for execution in a sequence or order based on a dataflow of the instruction block and/or based on a sequence of memory operations of the instruction block. Data associated with load and/or store instructions can be fetched and/or pre-fetched during the execute state. The instruction block can be executing speculatively or non-speculatively. A speculative block can execute to completion or it can be terminated prior to completion, such as when it is determined that work performed by the speculative block will not be used. When an instruction block is terminated, the processor can transition to the abort state. A speculative block can complete when it is determined the work of the block will be used, all register writes are buffered, all writes to memory are buffered, and a branch target is calculated, for example. A non-speculative block can execute to completion when all register writes are buffered, all writes to memory are buffered, and a branch target is calculated, for example. The execute state can be multiple cycles long and can overlap with the fetch (620) and decode (630) states when the processor core is pipelined. When the instruction block is complete, the processor can transition to the commit state.

At state 650, the state of the respective processor core can be commit or abort. During commit, the work of the instructions of the instruction block can be atomically committed so that other blocks can use the work of the instructions. In particular, the commit state can include a commit phase where locally buffered architectural state is written to architectural state that is visible to or accessible by other processor cores. When the visible architectural state is updated, a commit signal can be issued and the processor core can be released so that another instruction block can be executed on the processor core.

During the abort state, the pipeline of the core can be halted to reduce dynamic power dissipation. In some applications, the core can be power gated to reduce static power dissipation. Overlapping with or at the conclusion of the commit/abort states, the processor core can receive a new instruction block to be executed on the processor core, the core can be refreshed, the core can be idled, or the core can be reset.

At state 660, it can be determined if the instruction block resident on the processor core can be refreshed. As used herein, an instruction block refresh or a processor core refresh means enabling the processor core to re-execute one or more instruction blocks that are resident on the processor core. In one embodiment, refreshing a core can include resetting the active-ready state for one or more instruction blocks. It may be desirable to re-execute the instruction block on the same processor core when the instruction block is part of a loop or a repeated sub-routine or when a speculative block was terminated and is to be re-executed. The decision to refresh can be made by the processor core itself (contiguous reuse) or by outside of the processor core (non-contiguous reuse). For example, the decision to refresh can come from another processor core or a control core performing instruction block scheduling. There can be a potential energy savings when an instruction block is refreshed on a core that already executed the instruction as opposed to executing the instruction block on a different core. Energy is used to fetch and decode the instructions of the instruction block, but a refreshed block can save most of the energy used in the fetch and decode states by bypassing these states. In particular, a refreshed block can re-start at the execute state (640) because the instructions have already been fetched and decoded by the core. When a block is refreshed, the decoded instructions and the decoded ready state can be maintained while the active ready state is cleared. The decision to refresh an instruction block can occur as part of the commit operations or at a later time. If an instruction block is not refreshed, the processor core can be idled.

At state 670, the state of the respective processor core can be idle. The performance and power consumption of the block-based processor can potentially be adjusted or traded off based on the number of processor cores that are active at a given time. For example, performing speculative work on concurrently running cores may increase the speed of a computation but increase the power if the speculative misprediction rate is high. As another example, immediately allocating new instruction blocks to processors after committing or aborting an earlier executed instruction block may increase the number of processors executing concurrently, but may reduce the opportunity to reuse instruction blocks that were resident on the processor cores. Reuse may be increased when a cache or pool of idle processor cores is maintained. For example, when a processor core commits a commonly used instruction block, the processor core can be placed in the idle pool so that the core can be refreshed the next time that the same instruction block is to be executed. As described above, refreshing the processor core can save the time and energy used to fetch and decode the resident instruction block. The instruction blocks/processor cores to place in an idle cache can be determined based on a static analysis performed by the compiler or a dynamic analysis performed by the instruction block scheduler. For example, a compiler hint indicating potential reuse of the instruction block can be placed in the header of the block and the instruction block scheduler can use the hint to determine if the block will be idled or reallocated to a different instruction block after committing the instruction block. When idling, the processor core can be placed in a low-power state to reduce dynamic power consumption, for example.

At state 680, it can be determined if the instruction block resident on the idle processor core can be refreshed. If the core is to be refreshed, the block refresh signal can be asserted and the core can transition to the execute state (640). If the core is not going to be refreshed, the block reset signal can be asserted and the core can transition to the unmapped state (605). When the core is reset, the core can be put into a pool with other unmapped cores so that the instruction block scheduler can allocate a new instruction block to the core.

### IX. Examples of Out-of-Order Architectures

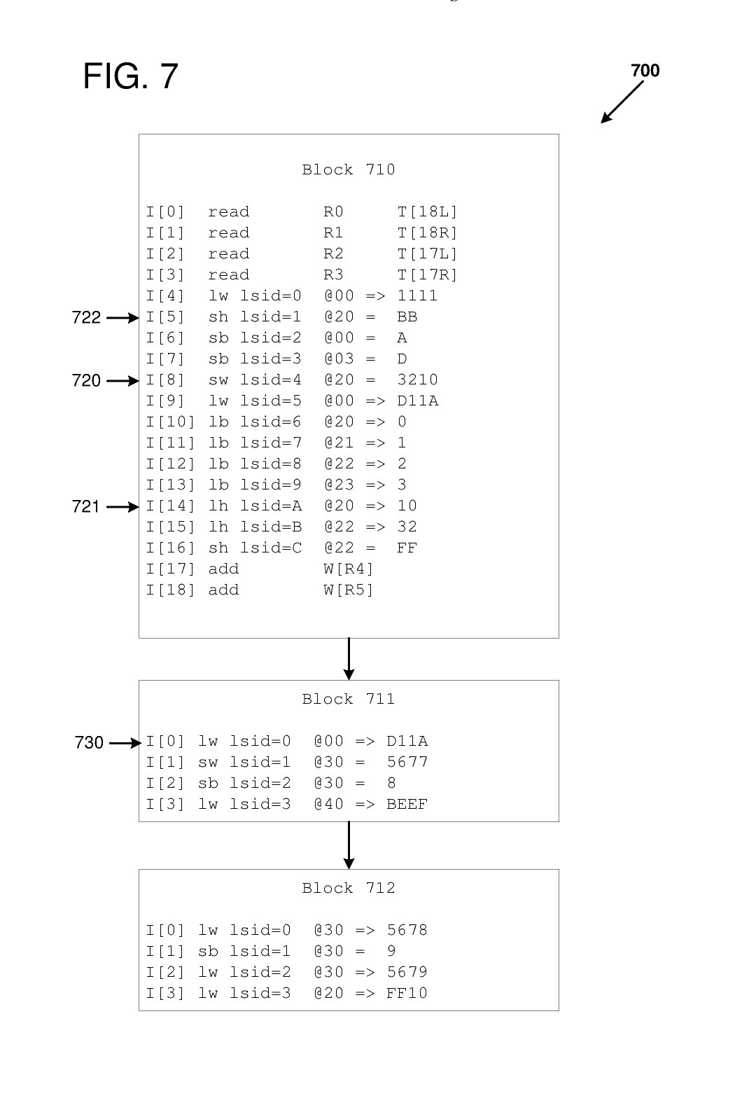

FIG. 7 illustrates an example snippet of instructions 700 of a program for a block-based processor. The program can include multiple blocks of instructions, such as instruction blocks 710-712. The execution order of the instruction blocks 710-712 is determined dynamically at run-time based on control decisions of the program. As illustrated, the block 710 is followed by block 711 which is followed by 712. An instruction block is a predefined group of instructions that are to be executed as a group. For example, compiler can divide a program into one or more instruction blocks. A given instruction block can include a single basic block, a portion of a basic block, or multiple basic blocks, so long as the instruction block can be executed within the constraints of the ISA and the hardware resources of the targeted computer. A basic block is a block of code where control can only enter the block at the first instruction of the block and control can only leave the block at the last instruction of the basic block. Thus, a basic block is a sequence of instructions that are executed together. Multiple basic blocks can be combined into a single instruction block using predicated instructions so that intra-instruction-block branches are converted to dataflow instructions. The instruction blocks 710-712 can each be atomically executed on a block-based processor core of a processor. For example, the instructions of a given instruction block are executed together and any changes made to visible architectural state by any of the instructions of the instruction block are made before the next instruction block accesses the visible architectural state. Updating the visible architectural state can include writing to registers and/or to memory.

Each of the instruction blocks 710-712 can include load and store instructions for writing and reading to memory at various granularities and non-load-store instructions for performing functions that do not access the memory. For example, the non-load-store instructions can include a read instruction for reading from a register and an add instruction for adding two operands. The load instructions can include a load word (lw) (e.g., four bytes), a load half-word (lh) (e.g., two bytes), and a load byte (lb) (e.g., one byte) instruction. Similarly, the store instructions can include a store word (sw) (e.g., four bytes), a store half-word (sh) (e.g., two bytes), and a store byte (sb) (e.g., one byte) instruction. Each of the load and store instructions can include a memory address from which to load or store data. For example, the memory can be byte-addressable. As illustrated in FIG. 7, the addresses are indicated with the “@” symbol and the addresses are hexadecimal byte addresses. A store instruction can include data that is to be written to the memory. As illustrated in FIG. 7, the store data of an instruction is presented after the “=” symbol and is in hexadecimal. A load instruction can respond with or return data that is read or loaded from the memory. As illustrated in FIG. 7, the expected load response data of an instruction is presented after the “=>” symbol and is in hexadecimal.

The instructions are ordered within the instruction blocks. A program order of the instructions is the order that is specified by a source code and/or object code program. For example, the program can embody an execution order intended by a programmer. Programs are typically written in source code and a compiler can convert the source code into object code or machine code that a processor can execute. The machine code can be emitted from the compiler and stored in memory in a sequential order. For example, the block 710 includes nineteen instructions labelled I[0] to I[18]. Thus, each of the instructions of the instruction block can have a unique identifier indicating the order in which the instruction is stored in memory. The order that the instructions are stored in memory can be the same or different than the program order. Additionally, the order of the memory operations relative to each other can be separately tracked from the order of all of the instructions within the instruction block. Specifically, each load and store instruction can include a load-store identifier (LSID or lsid) assigned by the compiler. The LSID indicates a relative program order of the load and store instructions with respect to each other while excluding the non-load-store instructions. As one example, an instruction with a lower LSID can indicate the instruction is earlier in the program order than an instruction with a higher LSID. In particular, instruction 720 (having an instruction identifier=8, and an LSID=4) is earlier in program order than instruction 721 (having an instruction identifier=14, and an LSID=A) and later in program order than instruction 722 (having an instruction identifier=5, and an LSID=1). It should be noted that for ease of illustration, some aspects of the load and store instructions may be omitted from FIG. 7. For example, the load and store instructions of the example code 700 use constant addresses rather than addresses that are generated by adding a base address to an offset.

An out-of-order processor can execute the instructions in an order different from the program order and/or different from the order that the instructions are stored in memory. For example, the processor can execute the instructions in a data-flow order that is different from the program order. In order to maintain correct operation of the program, the execution order must account for data dependencies between the instructions. The non-load-store instructions can be scheduled for execution using different criteria than when scheduling the load and store instructions.

Generally, load and store instructions can complete out-of-program order if the target addresses of the load and store instructions are non-overlapping. However, if the load and store instructions have overlapping target addresses, then the program order of the load and store instructions is taken into account when completing the load and store instructions. Because addresses can be calculated at run-time, determining whether the loads and stores are to overlapping addresses is a dynamic run-time decision. Determining whether a series of loads and stores are to overlapping addresses can be expensive in terms of hardware resources and energy consumption. For example, a load-store queue can be used to determine which loads and stores have overlapping addresses and can forward store data to load instructions when the load and store instructions are executed out-of-order. Alternatively, the load-store queue can be omitted if particular ones of the loads and stores are scheduled to execute in program order. As described above, the compiler can convey the program order to the decode/execution logic using an explicitly encoded LSID field for each load and store instruction, a mapping field in an instruction header of the instruction block, or an emitted order of the load and store instructions.

Loads and stores to overlapping target addresses can create data dependencies such as read-after-write (RAW), write-after-read (WAR), and write-after-write (WAW) dependencies. For the read-after-write dependency, a load instruction that occurs later in program order than a store instruction to the same target address should return the data written by the store instruction. For the write-after-read dependency, a load instruction that occurs earlier in program order than a store instruction to the same target address should return the data stored at the target address before the store instruction updates the data at the target address. For the write-after-write dependency, data written by a first store instruction that occurs earlier in program order than a second store instruction to the same target address should be overwritten by the data of the second store instruction.

Data dependencies can occur within instruction blocks and between instruction blocks. The example 700 illustrates many different RAW, WAR, and WAW dependencies within and between instruction blocks and the expected results from the load and store instructions. One example of a read-after-write dependency within an instruction block is the load instruction 721 following the store instruction 720 in block 710. When the program order (as indicated by their respective LSIDs) of the instructions 720 and 721 is taken into account, the store value “10” is written to address 21 and the “10” is read out by the load instruction 721. Thus, the response data provided by the load 721 is dependent on the store 720. However, if the instructions 720 and 721 were completed out of program order (e.g., in reverse order), the read response data returned by instruction 721 could be the “BB” (stored by instruction 722) instead of the “10” stored by instruction 720. If instruction 721 returned a “BB” an error would be introduced in the program. One example of a read-after-write dependency between instruction blocks is the load instruction 730 in block 711 following the store instruction 720 in block 710. For correct operation, the load instruction 730 will return the data (e.g., “D11A”) written by the store instruction 720.

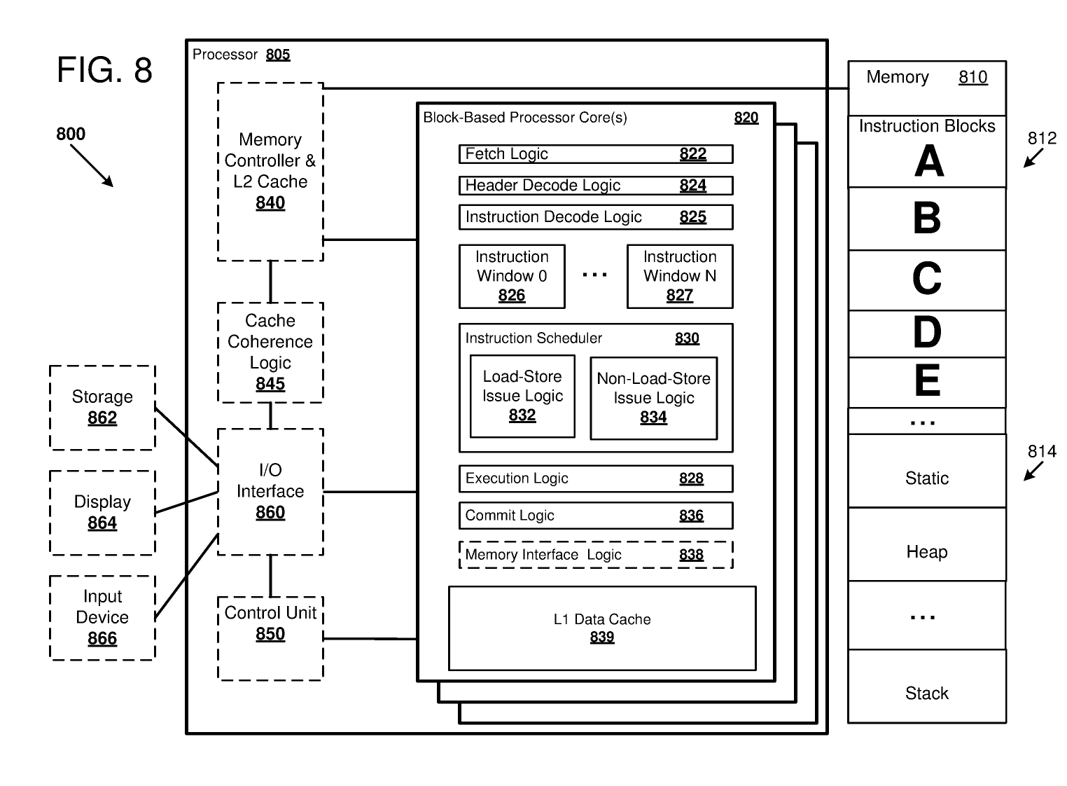

FIG. 8 illustrates an example computing system 800 including an out-of-order instruction scheduler 830. The computing system 800 can be used for executing a program on a block-based processor core. For example, the program can include the instruction blocks A-E. The instruction blocks A-E can be stored in a memory 810 that can be accessed by the processor 805. The processor 805 can include a plurality of block-based processor cores (including block-based processor core 820), an optional memory controller and level-two (L2) cache 840, cache coherence logic 845, a control unit 850, and an input/output (I/O) interface 860. The block-based processor core 820 can communicate with a memory hierarchy or memory sub-system used for storing and retrieving instructions and data of the program.

The memory hierarchy can be used to potentially increase the speed of accessing data stored in the memory 810. Generally, a memory hierarchy includes multiple levels of memory having different speeds and sizes. Levels within or closer to the processor core are generally faster and smaller than levels farther from the processor core. For example, a memory hierarchy can include a level-one (L1) cache within a processor core, a level-two (L2) cache within a processor that is shared by multiple processor cores, main memory that is off-chip or external to the processor, and backing store that is located on a storage device, such as a hard-disk drive. When the memory hierarchy is accessed, the faster and closer levels of the memory hierarchy can be accessed before the slower and farther levels of the memory hierarchy. As one example, the memory hierarchy can include the level-one (L1) cache 839, the memory controller and level-two (L2) cache 840, and the memory 810. The memory controller and the level-two (L2) cache 840 can be used to generate the control signals for communicating with the memory 810 and to provide temporary storage for information coming from or going to the memory 810. As illustrated in FIG. 8, the memory 810 is off-chip or external to the processor 805. However, the memory 810 can be fully or partially integrated within the processor 805.

The control unit 850 can be used for implementing all or a portion of a run-time environment for the program. The runtime environment can be used for managing the usage of the block-based processor cores and the memory 810. For example, the memory 810 can be partitioned into a code segment 812 comprising the instruction blocks A-E and a data segment 815 comprising a static section, a heap section, and a stack section. As another example, the control unit 850 can be used for allocating processor cores to execute instruction blocks. The optional I/O interface 860 can be used for connecting the processor 805 to various input devices (such as an input device 866), various output devices (such as a display 864), and a storage device 862. In some examples, the components of the processor core 820, the memory controller and L2 cache 840, the cache coherence logic 845, the control unit 850, and the I/O interface 860 are implemented at least in part using one or more of: hardwired finite state machines, programmable microcode, programmable gate arrays, or other suitable control circuits. In some examples, the cache coherence logic 845, the control unit 850, and the I/O interface 860 are implemented at least in part using an external computer (e.g., an off-chip processor executing control code and communicating with the processor 805 via a communications interface (not shown)).

All or part of the program can be executed on the processor 805. Specifically, the control unit 850 can allocate one or more block-based processor cores, such as the processor core 820, to execute the program. The control unit 850 can communicate a starting address of an instruction block to the processor core 820 so that the instruction block can be fetched from the code segment 812 of the memory 810. Specifically, the fetch logic 822 can issue a read request to the memory controller and L2 cache 840 for the block of memory containing the instruction block. The memory controller and L2 cache 840 can return the instruction block to the processor core 820. The instruction block can include an instruction header and instructions. The instruction header can be decoded by the header decode logic 824 to determine information about the instruction block, such as a store mask of the instruction block. The individual instructions of the instruction block can be decoded by the instruction decode logic 825 and information from the decoded instructions can be stored in instruction windows 826 and 827. The instructions of the instruction block can be issued or scheduled dynamically for execution by the instruction issue logic 830, based at least on when the instruction operands become available. Thus, the issued or execution order of the instructions can be different from the program order of the instructions. The instructions can be fully or partially executed using execution logic 828 (such as arithmetic logic units). As the instructions execute, intermediate values of the instruction block (such as operand buffers of instruction windows 826 and 827) are calculated and stored locally within state of the processor core 820. The execution logic 828 can include or communicate with memory interface logic 838 for accessing memory using memory instructions (e.g., load and store instructions). Commit logic 836 can track the status of the executing instructions of the instruction block and can commit the instruction block when commit conditions are completed. For example, commit conditions can include completing all register writes and memory stores of the instruction block and calculating a branch target address for a next instruction block. In one embodiment, the next instruction block can be fetched once the current instruction block commits In this manner, the work of all of the instructions of the current instruction block can be released as a single transaction to the next instruction block when the current instruction block commits.

The instruction scheduler 830 can include load-store issue logic 832 and non-load-store issue logic 834. The non-load-store issue logic 834 can be used to issue non-load-store instructions (such as the instructions I[0-3] and I[17-18] of block 710 in FIG. 7) for execution. For example, the non-load-store issue logic 834 can schedule the non-load-store instructions for execution based on a dataflow order that may be different from the program order. In particular, the instructions can be scheduled to execute when the operands of the instructions are ready. Using the example 700 from FIG. 7, the instructions I[0-3] of block 710 can issue in any order relative to each other because there are no dependencies between the instructions I[0-3]. However, the instruction I[17] cannot issue until its operands are calculated by the instructions I[2] and I[3]. Similarly, the instruction I[18] cannot issue until its operands are calculated by the instructions I[0] and I[1]. There are no dependencies between the instructions I[17] and I[18] so they can also issue in any order relative to each other (once their operands are ready). As illustrated, there are no dependencies between the load and store instructions (I[4-16]) and the non-load-store instructions and so the non-load-store instructions can issue in any order relative to the load-store instructions. In other examples, there can be dependencies between the non-load-store instructions and the load and store instructions. Any dependencies between the non-load-store instructions and the load and store instructions can be tracked using the instruction windows 826 and 827. For example, non-load-store instructions can be used for calculating target addresses of the load and store instructions.

The load-store issue logic 832 can be used to issue the load and store instructions for execution. For example, the load-store issue logic 832 can issue the load and store instructions based on when target addresses of the load and store addresses are calculated (such as by using non-load-store instructions) and based on a relative program order of the load and store instructions. Specifically, the load-store issue logic 832 can issue the load and store instructions for execution in an order so that all data dependencies between the load and store instructions are satisfied and sequential memory semantics are preserved. Rather than using a load-store queue to buffer load and store data and to search for overlapping target addresses within the individual load and store instructions, the load-store issue logic 832 can use compiler-generated information about the relative order of the memory operations to ensure the data dependencies are satisfied. By omitting a load-store queue, the store instruction data is written directly to the memory hierarchy and the load data is read directly from the memory hierarchy.

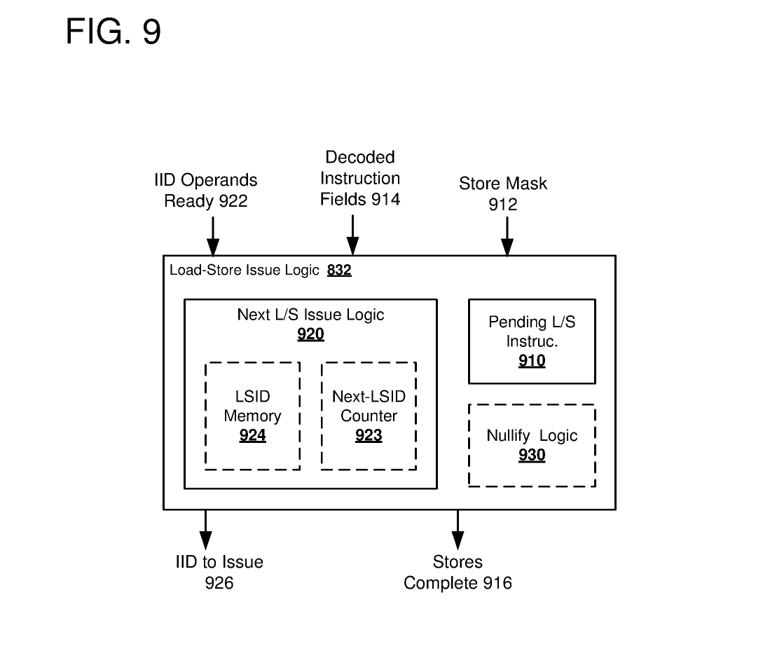

FIG. 9 illustrates different components of the load-store issue logic 832. Components of the load-store issue logic 832 can include pending load-store instruction data structures 910 and next-load-store instruction issue logic 920. In some examples, the components are implemented at least in part using one or more of: hardwired finite state machines, programmable microcode, programmable gate arrays, random access memory, or other suitable control circuits.

The pending load-store instruction data structures 910 can be used to track the status of load and store instructions within a resident instruction block. Specifically, the pending load-store instruction data structures 910 can include a pending-store data structure and a pending-load data structure. For example, the data structures can include a bitmask, where each bit of the bitmask can correspond to an LSID. Thus, when an instruction block can include a maximum of 32 load and store instructions, each bitmask can be 32 bits wide.

The pending load-store instruction data structures 910 can be initialized when a new instruction block is fetched and at least partially decoded. For example, an instruction header of the instruction block can include a store mask 912. As another example, the store mask 912 can be encoded within an instruction specifying the store mask 912. The store mask 912 can be communicated from the decode logic (e.g., header decode logic 824) to the load-store issue logic 832. The store mask 912 can be a bitmask with a bit corresponding to each possible LSID of the instruction block. Each asserted (e.g., a one value) bit of the store mask 912 can indicate that the LSID corresponding to the bit is a store instruction. Each deasserted (e.g., a zero value) bit of the store mask 912 can indicate that the LSID corresponding to the bit is a load instruction or not used for the instruction block. As a specific example, if store instructions of the instruction block are assigned LSIDs of 3, 6, and 9, bits 3, 6, and 9 of the store mask will be asserted. As another example, the lower sixteen bits of the store mask for block 710 from FIG. 7 can be “0001_0000_0001_1110” because the store instructions have LSIDs of one, two, three, four, and thirteen (hexadecimal C). When the store mask 912 is communicated from the decode logic to the load-store issue logic 832, the pending-store bitmask can be initialized with the value from the store mask since all stores of the block are pending before they are executed. The pending-load bitmask can be cleared when it is initialized since the LSIDs assigned to the load instructions may not be known until the individual instructions are decoded. Alternatively, a load mask can be included in the instruction header, and the load mask can be used to initialize the pending-load bitmask with all of the loads that can be executed within the instruction block. As yet another alternative, a combined mask using multiple bits for each LSID can be used to provide information about the make-up and position of the load and store instructions. For example, a two-bit field can be used to indicate whether a load or store instruction is present for a given LSID, and whether the instruction is a load or a store. As yet another alternative, the store mask 912 can be omitted and the pending-store bitmask can be generated as the individual store instructions are decoded.

The pending load-store instruction data structures 910 can be updated when individual instructions of the instruction block are decoded. For example, the decode logic (e.g., instruction decode logic 825) can communicate decoded instruction fields 914 to the load-store issue logic 832. As a specific example, the decoded instruction fields 914 can include an instruction identifier (IID) corresponding to a reference to the decoded instruction (e.g., a storage location in the instruction windows 826 and 827), an LSID, and a load-store field indicating whether the instruction is a load, a store, or a non-load-store instruction. The IID can be unique for each decoded instruction of the instruction block. For example, the IID can be the sequential number of the instruction within the instruction block and/or can be the storage location of the decoded instruction within the instruction window. When a load instruction is detected, the pending-load bitmask can be updated. Specifically, the bit corresponding to the LSID of the detected load instruction can be asserted in the pending-load bitmask to indicate that a load instruction with the LSID is pending. When the store mask 912 is used, the newly decoded store instructions can be ignored since the store mask 912 conveys the information about which LSIDs are used by the store instructions. If a store mask 912 is not used, the bit corresponding to the LSID of the detected store instruction can be asserted in the pending-store bitmask to indicate that a store instruction having the LSID is pending.

The next-load-store instruction issue logic 920 can use the pending load-store instruction data structures 910 to determine when a load or store instruction can be issued to the execution logic. Specifically, the next-load-store instruction issue logic 920 can determine the next load or store instruction to issue based on which load and store instructions of the instruction block have been issued and the relative program ordering of the load and store instructions with respect to each other. The next-load-store instruction issue logic 920 can operate using at least two different approaches. In one approach, the load and store instructions of the instruction block are generally issued in a sequential order indicated by the LSIDs. Thus, the instruction having an LSID of zero will be issued before the instruction having an LSID of one, and so forth. In another approach, the store mask 912 can be used to schedule the load and store instructions so that the load instructions are scheduled to be executed only after all store instructions preceding the load instructions have executed. For example, the store mask 912 can be used to identify the store instructions, the store instructions can be generally issued in the sequential order indicated by the LSIDs, and the load instructions between a pair of store instructions can be issued out of program order but after the first store instruction and before the second store instruction of the pair. As a specific example, if a group of load instructions (having LSIDs of five to seven) are positioned between store instructions with LSIDs of four and eight, the individual load instructions of the group can be issued in any order, so long as the load instructions are issued after the store instruction having the LSID of four and before the store instruction having the LSID of eight. Thus, the instructions can be issued in the order {4, 7, 5, 6, 8} or {4, 6, 5, 7, 8}, for example.

The next-load-store instruction issue logic 920 cannot issue a load or store instruction unless all dependencies for the load or store instruction are satisfied. For example, instructions earlier in program order can be used to calculate a target address of the load or store instruction. In other words, the earlier instructions may provide values for the operands of the load or store instruction. Thus, the IID operands ready signal 922 can be used to indicate that all operands for the instruction with the corresponding IID have been stored in the instruction window and that the instruction is capable of being issued. The IID operands ready signal 922 can include a bit vector, where each bit of the vector corresponds to a given IID. Thus, the ready-status of all the instructions of the instruction window can be determined by analyzing the bit vector of the IID operands ready signal 922. Specifically, an asserted bit can indicate that the instruction having the IID is ready and a deasserted bit can indicate that the instruction having the IID is not ready.

A mapping can be performed between the IID and the LSID because there can be more instructions (and IIDs) than LSIDs since there may be non-load-store instructions as well as load and store instructions in the instruction block. For example, the mapping between the LSID and the IID can be performed during instruction decode and stored in a LSID memory 924 that is indexed by the LSID. From example 700 of FIG. 7, the instruction 720 includes an IID of eight and an LSID of four, so an eight can be written at address location four of the LSID memory 924. As another example, the instruction 721 includes an IID of fourteen and an LSID of ten (hexadecimal A), so a fourteen can be written at address location ten of the LSID memory 924. Using the LSID memory 924 enables decoded instructions to be placed at any location within the instruction windows so that there is no fixed relationship between the IID and the LSID. As an alternative, decoded load and store instructions can always be mapped to a reserved area of the instruction windows so that there is a fixed mapping between the IID and the LSID. For example, when the ISA supports a maximum of 32 load and store instructions per instruction block, 32 locations within the instruction window can be reserved for the load and store instructions. When the compiler assigns an LSID to a single instruction, the LSID memory 924 can be sized to store a single IID. However, if the compiler can assign an LSID to multiple instructions (such as when the instructions are in mutually exclusive parallel predicated paths), the LSID can be sized to hold more than one IID.

When the load and store instructions are issued sequentially in the order provided by the LSIDs of the instructions, a next-LSID counter 923 can be used to track the LSID of the next load or store instruction to execute. The next-LSID counter 923 can be initialized as zero when a new instruction block is fetched by the processor core. The next-LSID counter 923 can be incremented each time that a load or store instruction is issued that matches the current value of the counter. In this manner, the load and store instructions can be sequentially issued according to the LSIDs of the load and store instructions.

The IID to issue signal 926 can be used to indicate that the load or store instruction matching the next-LSID counter 923 can be issued. Specifically, the IID to issue signal 926 can indicate the IID of the load or store instruction having the LSID that matches the next-LSID counter 923. As one example, the IID to issue signal 926 can be a bit vector where each bit of the vector corresponds to each possible IID of the instruction block. Thus, if the ISA allows a maximum of 128 instructions in an instruction block, the IID to issue signal 926 can be 128 bits wide. Alternatively, the IID to issue signal 926 can be a single bit wide, and the next-LSID counter value and the IID to issue signal 926 can be used to indicate when the instruction is to be issued. The IID to issue signal 926 can be asserted when the operands of the instruction are ready, as indicated by the IID operands ready signal 922.

Alternatively, the IID to issue signal 926 can be an encoded binary value (e.g., 5 bits can be used to encode up to 32 IIDs, 6 bits can be used to encode up to 64 IIDs, and so forth) and each instruction's slice of the scheduler logic can compare the binary IID value with its (constant) IID. Thus, a decoded load/store instruction with IID=7 will wait to issue until its input operand(s) are ready (e.g., a predicate and a base address) and its IID (e.g., 7) matches the IID to issue signal 926. In this embodiment, the IID to issue signal 926 can be complementary to or in addition to the usual dataflow scheduler operands-ready-logic. In particular, if a decoded instruction is designated or tagged as a “load/store memory access,” the issue logic checks for an additional condition before issuing the instruction, where the additional condition is that the IID matches the IID to issue signal 926.

The next-LSID counter 923 can be adjusted to account for predicated load and store instructions that may not be executed within the instruction block. For example, a nullify instruction can be used to indicate that a load or store instruction will not execute. Optional nullify logic 930 can be used to track the LSIDs and/or IIDs of nullified load or store instructions. For example, the nullify logic 930 can receive information from the execution logic when a nullify instruction is executed. The received information can include an IID or an LSID of one or more instructions to nullify. For example, the mapping from IID to LSID can be performed using the LSID memory 924. The nullify logic 930 can include a data structure for tracking the nullified instructions. For example, the data structure can be a bitmask or bit vector, where each bit corresponds to an LSID. The bit for a given LSID can be asserted when a load or store instruction having the LSID is nullified. The output of the next-LSID counter 923 can be compared to the nullified instructions as tracked by the nullify logic 930. If the value of the next-LSID counter 923 matches a nullified instruction, the counter 923 can be advanced to the next instruction that has not been nullified. Additionally, if the next sequential value of the counter 923 matches a nullified instruction, when the counter 923 is advanced, the counter 923 can be advanced to the next instruction that has not been nullified. In this manner, the load and store instructions can be issued in a sequential order, skipping over any load and store instructions that are predicated and not executed.

The store mask 912 can be used to schedule the load and store instructions so that the load instructions are scheduled to be executed only after all store instructions preceding the load instructions have executed. The store instructions are executed in the relative sequential order with respect to each other as indicated by the LSIDs of the store instructions. The load instructions between store instructions can be executed out-of-order. The load and store instructions from block 710 of FIG. 7 can be used as a specific example. The instructions with LSIDs=0-4 are issued in relative program order, but the load instructions with LSIDs=5-B can be issued out-of-order, but before the store instruction with LSID=C. For example, the load instructions with LSIDs=5-B can be issued in a dataflow order based on when the operands of the load instructions are ready. As a specific example, the instructions can be issued in the order {0, 1, 2, 3, 4, 9, 7, 5, 6, A, B, 8, C}, where the numbers in the sequence refer to the LSIDs. By issuing the load instructions out of program order, the instruction block may complete faster than if the load instructions were issued in program order. For example, operands of a load instruction later in the program order may be ready before operands of a load instruction earlier in the program order. Thus, the performance of the processor can potentially be increased by issuing the load instructions for execution out of program order.

The non-load-store instructions of the instruction block can be scheduled independently of the load and store instructions so long as there are no dependencies between the different instructions. For example, the non-load-store instructions can be scheduled in a dataflow order that is different from program order. As a specific example from FIG. 7, the non-load-store instructions with IIDs or 0-3 and 17-18 are independent of the load and store instructions and can be scheduled in a dataflow order such as {0, 1, 18, 2, 3, 17}, where the numbers in the sequence refer to the IIDs.

The pending load-store instruction data structures 910, initialized using the store mask 912, can be used to schedule the load and store instructions. For example, the lowest pending-store instruction and the lowest pending-load-or-store instruction can be determined. If the lowest pending-load-or-store instruction is a store instruction, the store instruction can be issued in relative program order as indicated by the LSIDs. However, if the lowest pending-load-or-store instruction is a load instruction, any of the load instructions with LSIDs less than the lowest pending-store instruction can be issued. If there are no pending store instructions, the remaining load instructions can be issued in any order. The selected load or store instruction to be issued can be indicated using the IID to issue signal 926. Alternatively, the instruction to issue can be identified by the LSID. When there are no pending store instructions, a stores complete signal 916 can be asserted. The stores complete signal 916 can be used as one of the criteria for determining when to commit the instruction block.

### X. Example Methods of Out-of-Order Processors

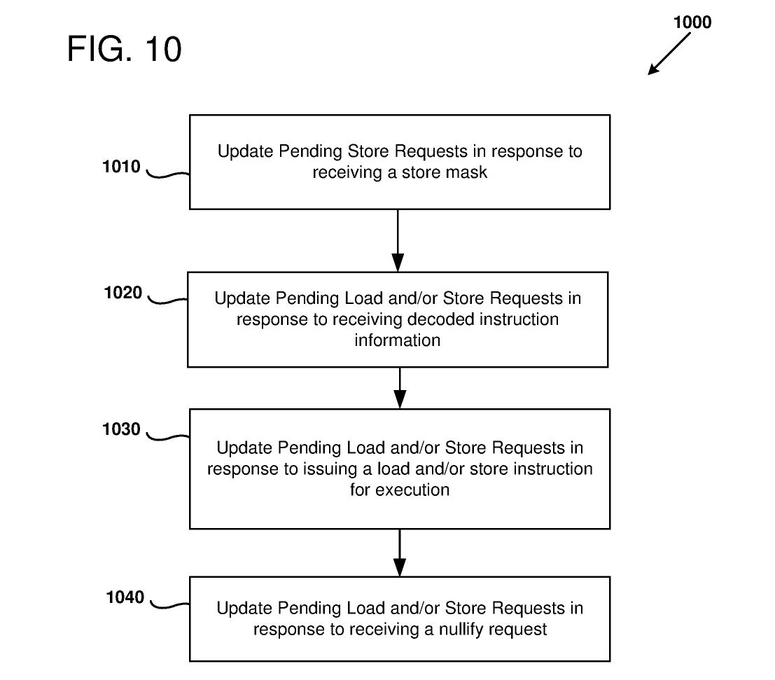

FIG. 10 is a flowchart illustrating an example method 1000 of maintaining a load-store data structure of the load-store issue logic, such as the load-store issue logic 832 of FIGS. 8-9.

At process block 1010, a pending-store request data structure can be updated in response to receiving a store mask. For example, the pending-store request data structure can include a bitmask, where each bit of the bitmask can correspond to an LSID. The store mask can indicate positions of all of the store instructions of the instruction block by the LSID of each store instruction. For example, the store mask can be a bitmask, where each asserted bit of the bitmask corresponds to an LSID of a store instruction. The store mask can be received after an instruction header of the instruction block is decoded, for example. The pending-store bitmask can be initialized by copying the values from the store mask to the pending-store bitmask. In this manner, the pending-store bitmask is initialized to indicate all of the store instructions that are pending for the instruction block.

A pending-load data structure can also be initialized in response to receiving an indication that the instruction header of the instruction block is decoded. For example, the pending-load data structure can include a pending-load bitmask. The pending-load bitmask can be initialized to all zeroes when the instruction header of the instruction block is decoded. Alternatively, the instruction header can include a load mask, and the pending-load bitmask can be initialized by copying the values from the load mask to the pending-load bitmask.

At process block 1020, the pending-load and/or pending-store request data structures can be updated in response to receiving decoded instruction information. For example, the decoded instruction information can be used to determine which instructions are load or store instructions and the LSID of each load and store instruction. An instruction that is decoded but has not been issued to execute is pending until the instruction is executed or is nullified. For example, the instruction can remain pending until the operands of the instruction are ready, the conditions to execute a load or store instruction having the LSID are met, and hardware resources are available to execute the instruction. A bit corresponding to the LSID of a decoded load instruction can be asserted in the pending-load bitmask when a load instruction having the LSID is detected. If a store mask is not used to initialize the pending store bitmask, a bit corresponding to the LSID of a decoded store instruction can be asserted in the pending-store bitmask when a store instruction having the LSID is detected.

At process block 1030, the pending-load and/or pending-store request data structures can be updated in response to issuing a load and/or store instruction for execution. For example, when a load instruction is issued, a bit corresponding to the LSID of the issued load instruction can be deasserted in the pending-load bitmask. Similarly, when a store instruction is issued, a bit corresponding to the LSID of the issued store instruction can be deasserted in the pending-store bitmask.

At process block 1040, the pending-load and/or pending-store request data structures can be updated in response to receiving a nullify request. For example, the nullify request can be generated by the execution logic when executing a nullify instruction. The nullify instruction can indicate that one or more load or store instructions will not be executed. For example, the nullify instruction can target a load or store instruction by the IID of the instruction. As another example, the nullify instruction can target a load or store instruction by the LSID of the instruction. As another example, the nullify instruction can use a mask to target load or store instructions within a range of LSIDs. When the instructions are nullified, the instructions are no longer pending. Thus, when a load instruction is nullified, a bit corresponding to the LSID of the nullified load instruction can be deasserted in the pending-load bitmask. Similarly, when a store instruction is nullified, a bit corresponding to the LSID of the nullified store instruction can be deasserted in the pending-store bitmask.

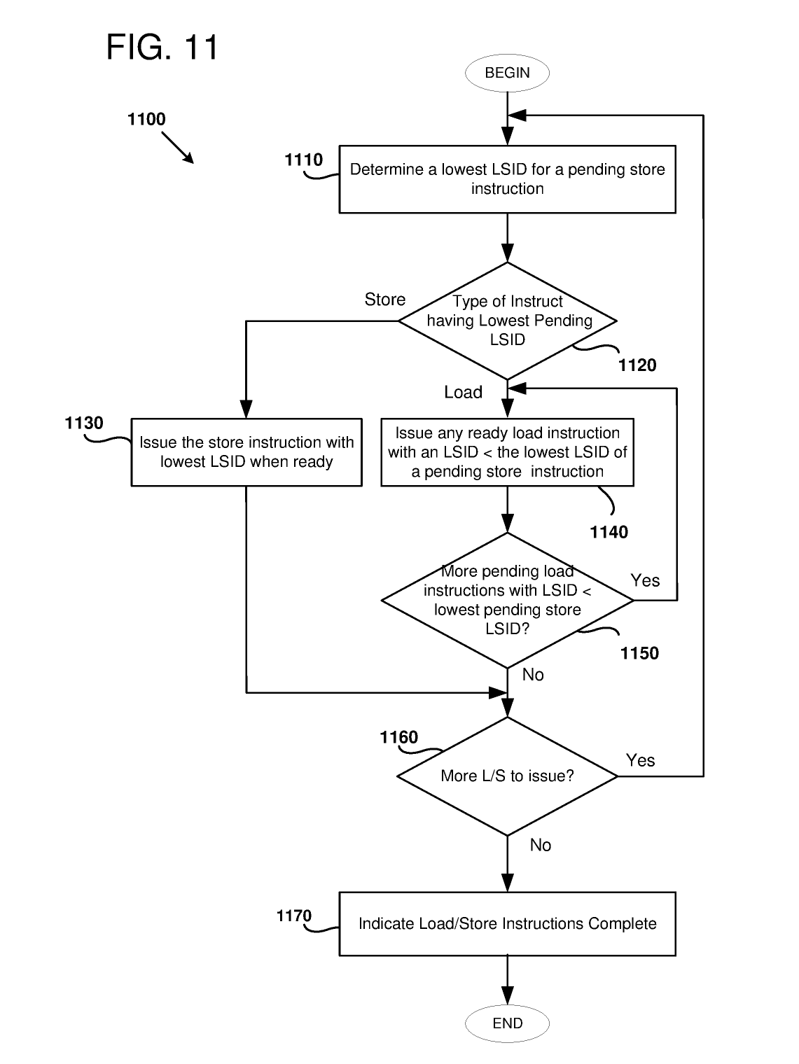

FIG. 11 is a flowchart illustrating an example method 1100 of issuing load and store instructions, such as can be performed by the load-store issue logic 832 of FIGS. 8-9.

At process block 1110, a lowest LSID for a pending store instruction can be determined. For example, the pending-store bitmask can be used to find the lowest LSID of the pending store instructions. In particular, the pending-store bitmask can be used as an input to a priority encoder that can output the lowest LSID for a pending store instruction.

At process block 1120, the type of instruction having the lowest pending LSID can be determined. For example, the pending-load bitmask can be used as an input to a priority encoder that can output the lowest LSID for a pending load instruction. The LSIDs of the lowest pending load instruction and the lowest pending store instruction can be compared. If the lowest pending LSID is a store instruction, the method 1100 can continue at process block 1130. If the lowest pending LSID is a load instruction, the method 1100 can continue at process block 1140.

At process block 1130, the store instruction with the lowest LSID can be issued when ready. The store instructions within an instruction block are issued in program order relative to each other so that write-after-write dependencies are satisfied. The store instruction can be issued when dependencies of the store instruction are satisfied, such as operands of the store instruction being ready, and hardware resources are available to execute the store instruction. The method 1100 can continue at process block 1160 after the store instruction with the lowest LSID is issued.

At process block 1140, any load instruction that is ready and has an LSID less than the pending store instruction with lowest LSID can be issued. For example, the LSIDs of the ready load instructions can be compared to the LSID of the lowest pending store instruction. Any of the load instructions with LSIDs less than the LSID of the lowest pending store instruction can be issued when dependencies of the load instruction are satisfied, such as operands of the load instruction being ready, and hardware resources are available to execute the load instruction. Thus, the load instructions with LSIDs less than the LSID of the lowest pending store instruction can be issued out of program order with respect to each other. As a specific example, the load instructions from block 710 of FIG. 7 with LSIDs between 5 and B can be issued in any order after the instructions with LSIDs less than 5 are issued and before the store instruction with LSID=C is issued.

Additionally, if there are no pending store instructions, the pending load instructions can be issued in any order when the pending load instructions are ready. As a specific example, the load instructions from block 712 of FIG. 7 with LSIDs between 2 and 3 can be issued in any order after the instructions with LSIDs less than 2 are issued.

At process block 1150, it can be determined whether there are additional pending load instructions with LSIDs less than the lowest LSID of the pending store instructions. If there are additional pending load instructions with LSIDs less than the lowest LSID of the pending store instructions, the method 1100 can continue at process block 1140. However, if there are no more additional pending load instructions with LSIDs less than the lowest LSID of the pending store instructions, the method 1100 can continue at process block 1160.

At process block 1160, it can be determined whether there are more load or store instructions to issue. For example, the pending-load and pending-store bitmasks can be compared to a zero value (such as by performing an or function). If both bitmasks are zero, there are no more load or store instructions to issue for this instruction block, and the method 1100 can continue at process block 1170. If there are more load or store instructions to issue, the method 1100 can continue at process block 1110.

At process block 1170, it can be indicated that all load and store instructions for the instruction block are complete, such as by asserting a complete signal. The complete signal can be used to determine if the instruction block can be committed and whether the next instruction block can be fetched. The instruction block is complete when the instruction block is committed. In an alternative embodiment, the complete signal can be asserted when all of the store instructions are completed.

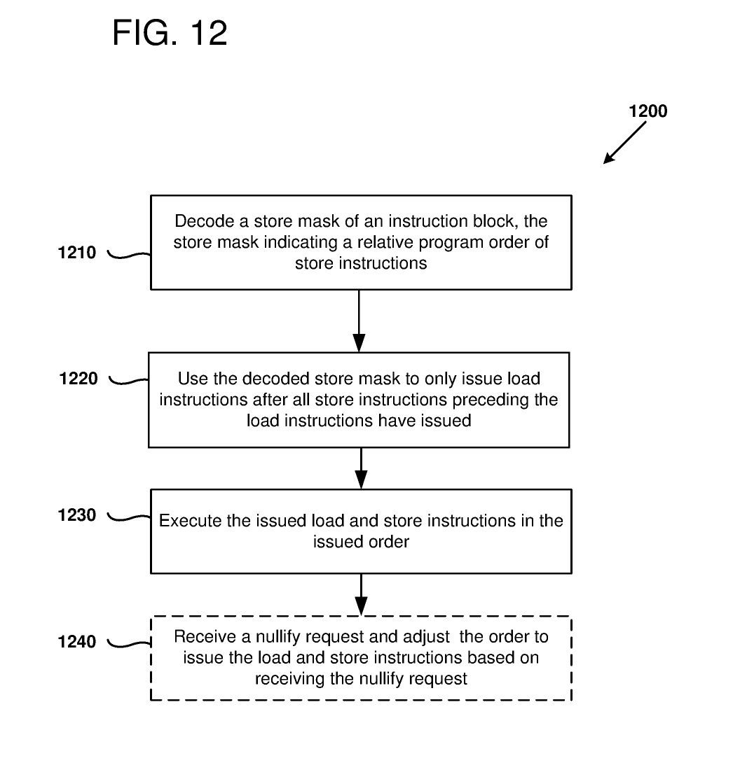

FIG. 12 is a flowchart illustrating an example method 1200 of executing an instruction block on a block-based processor core. The instruction block can include load, store, and/or non-load-store instructions. Each of the load and store instructions can include a load-store identifier (LSID) that indicates a relative program sequence of the load and store instructions. Each load and store instruction within the instruction block can have a unique LSID, or some load and store instructions may share an LSID. For example, predicated load and store instructions in mutually exclusive paths may share an LSID. Predicated instructions are conditionally executed depending upon the value of a predicate calculation performed at run-time of the instruction block.

At process block 1210, a store mask of the instruction block can be decoded. The store mask can indicate a relative program order of store instructions within the instruction block. As one example, the store mask can be a bitmask where each bit of the bitmask corresponds to an LSID of the load and store instructions, and the asserted bits of the store mask indicate the LSIDs of the store instructions. The non-asserted bits of the store mask can indicate the LSIDs of the load instructions and/or the absence of a load or store instruction with the LSID. For example, the store mask can be generated by a compiler and encoded in an instruction header of the instruction block. As another example, the store mask can be encoded in a data structure associated with a program incorporating the instruction block. As yet another example, the store mask can be encoded in an instruction of the instruction block that is used for identifying the store instructions.

At process block 1220, the decoded store mask can be used to only issue load instructions after all store instructions preceding the load instructions have issued. Each store instruction can be issued in relative program order to other store instructions of the instruction block. The relative program order can be determined based on the LSIDs of the instructions. In one embodiment, all of the load and store instructions of the instruction block can be issued in the relative program order specified by the LSIDs of the load and store instructions. In another embodiment, load instructions in between store instructions can be issued out-of-order. For example, the load instructions can be issued in dataflow order based on when operands of the load instructions are ready. The non-load-store instructions can be issued in dataflow order. The non-load-store instructions can be issued independently of the pending load and store instructions when the non-load-store instructions have no dependencies from the pending load and store instructions.

At process block 1230, the issued load and store instructions can be executed in the issued order. For example, issuing a load or store instructions can include routing operands and control signals of the load or store instruction to execution logic. The execution logic can include multiple execution units, such as arithmetic logic units (ALUs), floating point units (FPUs), and/or load-store units. The execution logic can perform a function of the load or store instruction when the load or store instruction is issued. For a store instruction, the execution logic can generate a store request to the memory hierarchy. For a load instruction, the execution logic can generate a load request to the memory hierarchy. The load request may block or stall the load-store execution logic while the load response data is being returned from the memory hierarchy. When the load-store execution unit is busy, load and store instructions later in the program order can be delayed until the load-store execution unit completes.

At optional process block 1240, a nullify request can be received. The order to issue the load and store instructions can be adjusted based on receiving the nullify request. The nullify request can indicate one or more load or store instructions that will not be executed, such as when the instructions are predicated and the predicate value is not matched. The nullify request can specify the non-executing instructions by IID or LSID, for example. A bulk-nullify request can include a bitmask that can be used to nullify multiple non-executing instructions. Nullified instructions will not be issued and so the nullified instructions can be removed from a list of pending instructions to issue. The order to issue the load and store instructions can be adjusted by skipping over the nullified instructions, for example.

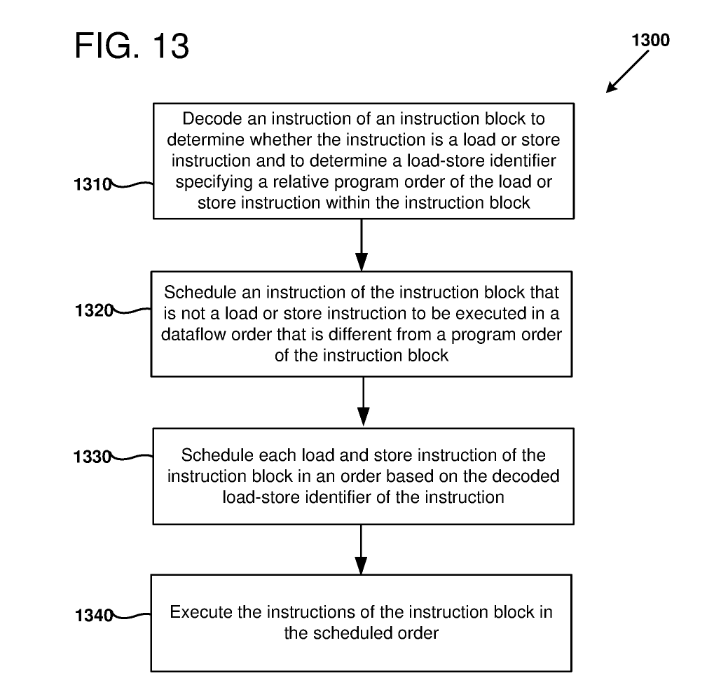

FIG. 13 is a flowchart illustrating an example method 1300 of executing an instruction block on a block-based processor core. The instruction block can include load, store, and/or non-load-store instructions.

At process block 1310, an instruction of the instruction block can be decoded to determine whether the instruction is a load or store instruction and to determine a load-store identifier (LSID) specifying a relative program order of the load or store instruction within the instruction block. For example, a compiler can detect a sequence of memory operations within a program, and the compiler can encode the detected sequence into the load and store instructions using an LSID field of each instruction. Thus, the LSID field can be specific to the memory instructions (e.g., the load and store instructions) and can be omitted for the non-load-store instructions. As another example, the compiler can emit the load and store instructions in program order so that the LSID of each load and store instruction can be imputed from the emitted order of the load and store instructions. As another example, the compiler can generate a field in an instruction header of the instruction block. Specifically, the field can map the LSID of each load and store instruction to an IID of the corresponding load or store instruction.

At process block 1320, a non-load-store instruction can be scheduled to be executed in a dataflow order that is different from a program order of the instruction block. For example, the non-load-store instructions can be scheduled based on when operands of the non-load-store instructions are ready.

At process block 1330, each load and store instruction of the instruction block can be scheduled in an order based on the decoded LSID of the instruction. As one example, the order to execute the load and store instructions of the instruction block can follow a sequential order of the decoded LSIDs of the load and store instructions. As another example, the order to execute the load and store instructions of the instruction block can be based on a store mask of the instruction block. The store mask can identify positions of the store instructions within the program order of the instruction block. In one example, the load instructions can be scheduled to be executed only after all store instructions preceding the load instructions have executed. The load instructions can execute out-of-order with respect to the other load instructions. In another example, the store instructions can be scheduled to execute in the order specified by the LSID and the store mask. A nullify instruction can be used to account for predicated instructions that are not executed during a given run of the execution block. For example, the issued order of the instructions can be adjusted based on a nullify instruction being executed.

At process block 1340, the instructions of the instruction block can be executed in the scheduled order. Thus, some instructions of the instruction block can be executed out of program order and the memory operations can be executed in an order that preserves sequential memory semantics. By executing some instructions out of program order based on when operands of the instructions are ready, the performance of the processor may be increased due to fewer stalls within the processor. By using the program order information of the memory operations when scheduling the load and store instructions, sequential memory semantics can be preserved without using a load-store queue. Thus, the processor can potentially be made smaller (e.g., less expensively) and more energy efficient.

### XI. Example Computing Environment

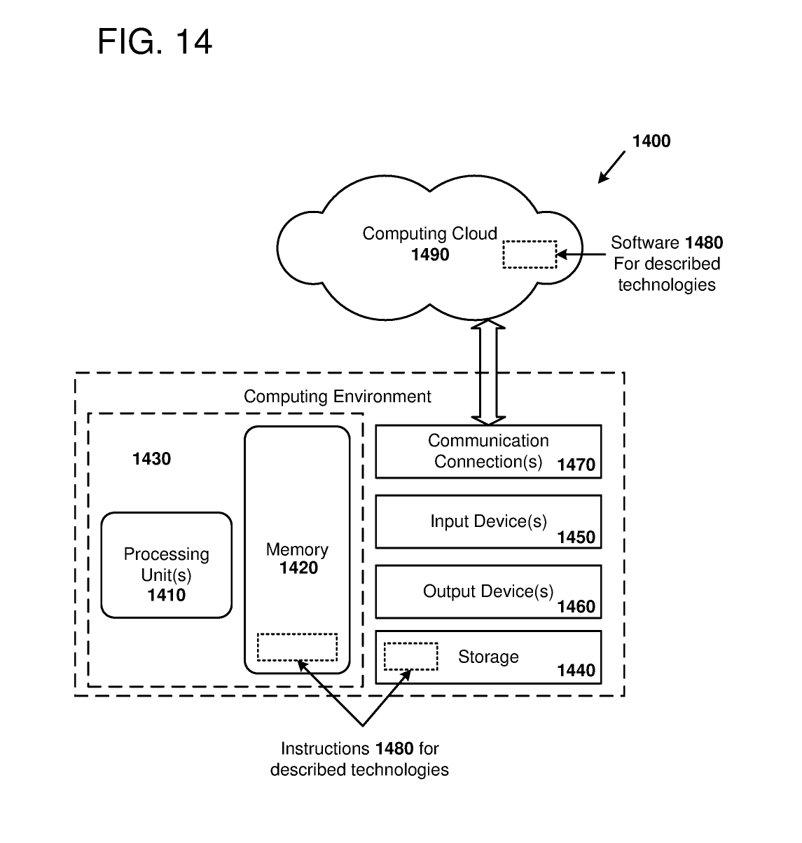

FIG. 14 illustrates a generalized example of a suitable computing environment 1400 in which the described embodiments, techniques, and technologies can be implemented.

The computing environment 1400 is not intended to suggest any limitation as to scope of use or functionality of the technology, as the technology may be implemented in diverse general-purpose or special-purpose computing environments. For example, the disclosed technology may be implemented with other computer system configurations, including hand held devices, multi-processor systems, programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules (including executable instructions for block-based instruction blocks) may be located in both local and remote memory storage devices.

With reference to FIG. 14, the computing environment 1400 includes at least one block-based processing unit 1410 and memory 1420. In FIG. 14, this most basic configuration 1430 is included within a dashed line. The block-based processing unit 1410 executes computer-executable instructions and may be a real or a virtual processor. In a multi-processing system, multiple processing units execute computer-executable instructions to increase processing power and as such, multiple processors can be running simultaneously. The memory 1420 may be volatile memory (e.g., registers, cache, RAM), non-volatile memory (e.g., ROM, EEPROM, flash memory, etc.), or some combination of the two. The memory 1420 stores software 1480, images, and video that can, for example, implement the technologies described herein. A computing environment may have additional features. For example, the computing environment 1400 includes storage 1440, one or more input devices 1450, one or more output devices 1460, and one or more communication connections 1470. An interconnection mechanism (not shown) such as a bus, a controller, or a network, interconnects the components of the computing environment 1400. Typically, operating system software (not shown) provides an operating environment for other software executing in the computing environment 1400, and coordinates activities of the components of the computing environment 1400.

The storage 1440 may be removable or non-removable, and includes magnetic disks, magnetic tapes or cassettes, CD-ROMs, CD-RWs, DVDs, or any other medium which can be used to store information and that can be accessed within the computing environment 1400. The storage 1440 stores instructions for the software 1480, plugin data, and messages, which can be used to implement technologies described herein.

The input device(s) 1450 may be a touch input device, such as a keyboard, keypad, mouse, touch screen display, pen, or trackball, a voice input device, a scanning device, or another device, that provides input to the computing environment 1400. For audio, the input device(s) 1450 may be a sound card or similar device that accepts audio input in analog or digital form, or a CD-ROM reader that provides audio samples to the computing environment 1400. The output device(s) 1460 may be a display, printer, speaker, CD-writer, or another device that provides output from the computing environment 1400.

The communication connection(s) 1470 enable communication over a communication medium (e.g., a connecting network) to another computing entity. The communication medium conveys information such as computer-executable instructions, compressed graphics information, video, or other data in a modulated data signal. The communication connection(s) 1470 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed agents, bridges, and agent data consumers. In a virtual host environment, the communication(s) connections can be a virtualized network connection provided by the virtual host.

Some embodiments of the disclosed methods can be performed using computer-executable instructions implementing all or a portion of the disclosed technology in a computing cloud 1490. For example, disclosed compilers and/or block-based-processor servers are located in the computing environment 1430, or the disclosed compilers can be executed on servers located in the computing cloud 1490. In some examples, the disclosed compilers execute on traditional central processing units (e.g., RISC or CISC processors).

Computer-readable media are any available media that can be accessed within a computing environment 1400. By way of example, and not limitation, with the computing environment 1400, computer-readable media include memory 1420 and/or storage 1440. As should be readily understood, the term computer-readable storage media includes the media for data storage such as memory 1420 and storage 1440, and not transmission media such as modulated data signals.

### XII. Additional Examples of the Disclosed Technology

Additional examples of the disclosed subject matter are discussed herein in accordance with the examples discussed above.

In one embodiment, a processor includes decode logic and issue logic. The decode logic is configured to decode a store mask of an instruction block. The instruction block includes load and store instructions, and each load and store instruction includes an identifier specifying a relative program order of the instruction within the instruction block. The store mask identifies positions of the store instructions within the program order of the instruction block. As one example, the store mask can be contained in an instruction header of the instruction block and the decode logic can include header decode logic configured to decode the instruction header. The issue logic is configured to issue at least one instruction of the instruction block out of program order and to use the decoded store mask to only issue load instructions after all store instructions preceding the load instructions have issued.

The issue logic can be further configured to issue each store instruction in program order relative to other store instructions of the instruction block. The issue logic can be further configured to issue all load and store instructions of the instruction block in the sequential program order specified by the identifiers of the load and store instructions. The issue logic can be further configured to receive a nullify request indicating that a load or store instruction will not be executed, and an order of issuing the instructions of the instruction block can be adjusted based on receiving the nullify request. The issue logic can be further configured to receive a bulk-nullify request indicating that a plurality of load or store instructions will not be executed, and an order of issuing the instructions of the instruction block can be adjusted based on receiving the bulk-nullify request.

The processor can be used in a variety of different computing systems. For example, a server computer can include non-volatile memory and/or storage devices; a network connection; memory storing one or more instruction blocks; and the processor including the block-based processor core for executing the instruction blocks. As another example, a device can include a user-interface component; non-volatile memory and/or storage devices; a cellular and/or network connection; memory storing one or more of the instruction blocks; and the processor including the block-based processor core for executing the instruction blocks. The user-interface component can include at least one or more of the following: a display, a touchscreen display, a haptic input/output device, a motion sensing input device, and/or a voice input device.

In one embodiment, a method can be used for executing computer-executable instructions. The method includes decoding an instruction of an instruction block to determine whether the instruction is a load or store instruction and to determine a load-store identifier specifying a relative program order of the load or store instruction within the instruction block. As one example, a respective load-store identifier can correspond to no more than one instruction of the instruction block. As another example, a respective load-store identifier can correspond to multiple instructions (e.g., predicated instructions) of the instruction block. The method includes scheduling an instruction of the instruction block that is not a load or store instruction to be executed in a dataflow order that is different from a program order of the instruction block. The method includes scheduling each load and store instruction of the instruction block in an order based on the decoded load-store identifier of the instruction. The method includes executing the instructions of the instruction block in the scheduled order.

The order to execute the load and store instructions of the instruction block can follow a sequential order of the decoded load-store identifiers of the load and store instructions. The sequential order of the decoded load-store identifiers of the load and store instructions can be maintained by nullifying one or more non-executed predicated load or store instructions.

The method can further include using a store mask of the instruction block to schedule the load and store instructions so that the load instructions are scheduled to be executed only after all store instructions preceding the load instructions have executed. The store mask can identify positions of the store instructions within the program order of the instruction block. The store mask can be decoded from a block header of the instruction block. The method can further include reading data from the memory hierarchy for at least one of the load instructions out of program order. The method can further include writing the data of each store instruction of the instruction block to the memory hierarchy in the relative order indicated by the load-store identifiers of the other store instructions. Decoding the instruction of the instruction block can include mapping an instruction identifier of the instruction to the load-store identifier of the instruction.

One or more computer-readable storage media can store computer-readable instructions that, when executed by a computer, cause the computer to perform the method.

In one embodiment, a block-based processor includes fetch logic, an instruction decoder, and a scheduler. The fetch logic is configured to fetch an instruction block comprising a plurality of instructions including load and store instructions. The instruction decoder is configured to determine a type of each instruction of the fetched instruction block, and when the type of the instruction is a load or store instruction, determine a load-store sequence number specifying a relative order of the load or store instruction within a sequence of memory operations of the instruction block. The scheduler is configured to issue decoded instructions that are not load or store instructions for execution in a dataflow order, and to issue decoded load and store instructions for execution in an order based on the decoded load-store sequence number of each load and store instruction. Thus, the load-store sequence numbers of the load and store instructions can be used to determine the execution order of the load and store instructions rather than the order that the load and store instructions appear within the instruction block. As an alternative example to encoding a load-store sequence number within the load and store instructions, an instruction header of the instruction block can include a load mask and a store mask to identify corresponding instructions as loads and stores of the instruction block. The scheduler can be configured to issue the load and store instructions for execution in an order based on the decoded load mask and store mask. As another alternative example to encoding a load-store sequence number within the load and store instructions, a load-store sequence number can be assigned to the load and store instructions based on the order the load and store instructions occur within the instruction block.

The block-based processor can further include header decode logic configured to decode an instruction block header of the fetched instruction block. The instruction block header can include a store mask identifying positions of the store instructions within the sequence of the memory operations of the instruction block. The decoded store mask can be used by the scheduler to determine when to issue the decoded load and store instructions for execution.

Each decoded load instruction can be issued for execution after all decoded store instructions preceding the decoded load instruction are issued for execution. Each decoded load and store instruction can be issued in the sequential order of the memory operations indicated by the load-store sequence number. The instructions of the instruction block can include a nullify instruction for nullifying one or more non-executed predicated load or store instructions, and the scheduler can be configured to adjust the order of issuing decoded load and store instructions based on the nullify instruction.

In view of the many possible embodiments to which the principles of the disclosed subject matter may be applied, it should be recognized that the illustrated embodiments are only preferred examples and should not be taken as limiting the scope of the claims to those preferred examples. Rather, the scope of the claimed subject matter is defined by the following claims. We therefore claim as our invention all that comes within the scope of these claims.

We claim:

1. A processor comprising:
decode logic configured to decode a store mask of an instruction block, the instruction block comprising load and store instructions, each load and store instruction including an identifier specifying a relative program order of the instruction within the instruction block, the store mask identifying positions of the store instructions within the program order of the instruction block; and
issue logic configured to issue at least one instruction of the instruction block out of program order, and to use the decoded store mask to only issue load instructions after all store instructions preceding the load instructions have issued.

2. The processor of claim 1, wherein the issue logic is further configured to issue each store instruction in program order relative to other store instructions of the instruction block.

3. The processor of claim 1, wherein the issue logic is further configured to issue all load and store instructions of the instruction block in the sequential program order specified by the identifiers of the load and store instructions.

4. The processor of claim 1, wherein the decode logic comprises header decode logic configured to decode an instruction header of the instruction block, and the store mask is contained in the instruction header.

5. The processor of claim 1, wherein the issue logic is further configured to receive a nullify request indicating that a load or store instruction will not be executed, and an order of issuing the instructions of the instruction block is adjusted based on receiving the nullify request.

6. The processor of claim 1, wherein the issue logic is further configured to receive a bulk-nullify request indicating that a plurality of load or store instructions will not be executed, and an order of issuing the instructions of the instruction block is adjusted based on receiving the bulk-nullify request.

7. A method for executing computer-executable instructions, the method comprising:
decoding an instruction of an instruction block to determine whether the instruction is a load or store instruction and to determine a load-store identifier specifying a relative program order of the load or store instruction within the instruction block;
scheduling an instruction of the instruction block that is not a load or store instruction to be executed in a dataflow order that is different from a program order of the instruction block;
scheduling each load and store instruction of the instruction block in an order based on the decoded load-store identifier of the instruction; and
executing the instructions of the instruction block in the scheduled order.

8. The method of claim 7, wherein the order to execute the load and store instructions of the instruction block follows a sequential order of the decoded load-store identifiers of the load and store instructions.

9. The method of claim 8, wherein the sequential order of the decoded load-store identifiers of the load and store instructions is maintained by nullifying one or more non-executed predicated load or store instructions.

10. The method of claim 7, further comprising:
using a store mask of the instruction block to schedule the load and store instructions so that the load instructions are scheduled to be executed only after all store instructions preceding the load instructions have executed, the store mask identifying positions of the store instructions within the program order of the instruction block.

11. The method of claim 10, further comprising reading data from the memory hierarchy for at least one of the load instructions out of program order.

12. The method of claim 10, further comprising writing the data of each store instruction of the instruction block to the memory hierarchy in the relative order indicated by the load-store identifiers of the other store instructions.

13. The method of claim 10, wherein the store mask is decoded from a block header of the instruction block.

14. The method of claim 10, wherein a respective load-store identifier corresponds to no more than one instruction of the instruction block.

15. The method of claim 10, wherein decoding the instruction of the instruction block comprises mapping an instruction identifier of the instruction to the load-store identifier of the instruction.

16. A block-based processor comprising:
fetch logic configured to fetch an instruction block comprising a plurality of instructions including load and store instructions;
an instruction decoder configured to determine a type of each instruction of the fetched instruction block, and when the type of the instruction is a load or store instruction, determine a load-store sequence number specifying a relative order of the load or store instruction within a sequence of memory operations of the instruction block; and
a scheduler configured to issue decoded instructions that are not load or store instructions for execution in a dataflow order, and to issue decoded load and store instructions for execution in an order based on the decoded load-store sequence number of each load and store instruction.

17. The block-based processor of claim 16, further comprising:
header decode logic configured to decode an instruction block header of the fetched instruction block, the instruction block header including a store mask identifying positions of the store instructions within the sequence of the memory operations of the instruction block, and wherein the decoded store mask is used by the scheduler to determine when to issue the decoded load and store instructions for execution.

18. The block-based processor of claim 16, wherein each decoded load instruction is issued for execution after all decoded store instructions preceding the decoded load instruction are issued for execution.

19. The block-based processor of claim 16, wherein each decoded load and store instruction is issued in the sequential order of the memory operations indicated by the load-store sequence number.

20. The block-based processor of claim 16, wherein the instructions of the instruction block include a nullify instruction for nullifying one or more non-executed predicated load or store instructions, and the scheduler is further configured to adjust the order of issuing decoded load and store instructions based on the nullify instruction.
